(19) United States
(12) Patent Application Publication
(10) Pub. No.: US 2012/0310720 A1
(43) Pub. Date: Dec. 6, 2012

(54) METHOD AND APPARATUS FOR PROCESSING COUPONS/PURCHASES BASED ON RADIO FREQUENCY MEMORY TAG DETECTION

(75) Inventors: Damien Balsan, Belmont, MA (US); Ismo Tapio Hautala, Espoo (FI); Mark Selby, Camberley (GB); Tapio Mika Kalevi Tolvanen, Sunnyvale, CA (US); Zahid N. Ahmed, Westborough, MA (US)

(73) Assignee: Nokia Corporation, Espoo (FI)

(21) Appl. No.: 13/436,136

(22) Filed: Mar. 30, 2012

Related U.S. Application Data
(60) Provisional application No. 61/470,166, filed on Mar. 31, 2011.

(51) Int. Cl. G06Q 30/02

(52) U.S. Cl. 705/14.26

(57) ABSTRACT

An approach is provided for processing promotional information for facilitating a point-of-sales transaction via radio frequency (RF) memory tags. A platform causes, at least in part, a capture of promotional information from a radio frequency memory tag associated with a merchant. The tags are placed at locations including a point-of-sales terminal, store entrance or near a poster to facilitate customer access. The platform processes and/or facilitates a processing of the promotional information to present one or more offers at a device, and receives an input for selecting at least one of the one or more offers for redemption. In response, the platform causes, at least in part, a validation of the redemption of at least one of the one or more offers. The platform then causes, at least in part, a presentation of the validation at the device for a confirmation by the merchant.

### RELATED APPLICATIONS

This application claims the benefit of the earlier filing date under 35 U.S.C. §119(e) of U.S. Provisional Application Ser. No. 61/470,166 filed on Mar. 31, 2011, entitled “Method and Apparatus for Processing Coupons Based on Radio Frequency Memory Tag Detection,” the entirety of which is incorporated herein by reference.

### BACKGROUND

Wireless (e.g., cellular) service providers and device manufacturers are continually challenged to deliver value and convenience to consumers by, for example, providing compelling services, applications, and content. One area of development is the distribution of coupons, promotions and other offers to device users in connection with various goods and/or services. By way of example, merchants and service providers place radio frequency (RF) tags at various locations within sight of mobile device users as a means of enabling product information exchange, transferring coupons and incentives, establishing proof of presence of the user at a store location and facilitating purchase transactions. Tags may be read by the mobile device using software for detecting, scanning and subsequently decoding information conveyed by the tags as they are affixed to product posters and advertisements or placed near the entrance of a store or point-of-sales (POS) terminal of the merchant or service provider. Unfortunately, merchants and service providers are limited in their ability to enable mobile device users to automatically discover and redeem coupons that are relevant to the merchant at the point-of-sale. Furthermore, many merchants are required to install additional hardware and software to enable their existing POS systems to securely interact with mobile devices for redeeming promotions and incentives.

### SOME EXAMPLE EMBODIMENTS

According to one embodiment, a method comprises causing, at least in part, capture of promotional information from a radio frequency memory tag associated with a merchant. The method also comprises processing and/or facilitating a processing of the promotional information to present one or more offers at a device. The method also comprises receiving an input for selecting at least one of the one or more offers for redemption. The method further comprises causing, at least in part, validation of the redemption of at least one of the one or more offers. The method further comprises causing, at least in part, presentation of the validation at the device for a confirmation by the merchant

According to another embodiment, an apparatus comprising at least one processor, and at least one memory including computer program code, that at least one memory and the computer program code configured to, with the at least one processor, cause the apparatus to capture promotional information from a radio frequency memory tag associated with a merchant. The apparatus is also caused to process and/or facilitate a processing of the promotional information to present one or more offers at a device. The apparatus is also caused to receive an input for selecting at least one of the one or more offers for redemption. The apparatus is further caused to validate the redemption of at least one of the one or more offers. The apparatus is further caused to present the validation at the device for a confirmation by the merchant.

According to another embodiment, a computer-readable storage medium carrying one or more sequences of one or more instructions which, when executed by one or more processors, cause an apparatus to capture promotional information from a radio frequency memory tag associated with a merchant. The apparatus is also caused to process and/or facilitate a processing of the promotional information to present one or more offers at a device. The apparatus is also caused to receive an input for selecting at least one of the one or more offers for redemption. The apparatus is further caused to validate the redemption of at least one of the one or more offers. The apparatus is further caused to present the validation at the device for a confirmation by the merchant.

According to yet another embodiment, an apparatus comprises means for causing, at least in part, capture of promotional information from a radio frequency memory tag associated with a merchant. The apparatus also comprises means for processing and/or facilitating a processing of the promotional information to present one or more offers at a device. The apparatus also comprises means for receiving an input for selecting at least one of the one or more offers for redemption. The apparatus further comprises means for causing, at least in part, validation of the redemption of at least one of the one or more offers. The apparatus further comprises means for causing, at least in part, presentation of the validation at the device for a confirmation by the merchant.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for automatically processing promotional/payment information for use in facilitating a point-of-sales transaction based on the reading or one or more radio frequency (RF) memory tags by a user device, according to one embodiment;

FIG. 1B is a flowchart of a process for initiating a user device for enabling the detection and maintenance of promotional/payment information based on one or more RF memory tags, according to one embodiment;

FIG. 2A is a diagram of components of a offer/purchase management platform, according to one embodiment;

FIGS. 2B and 2C respectively are components of a tag-based content module and a services platform, according to various embodiments;

FIGS. 3A and 3B are flowcharts of a process for facilitating processing of promotional information based on one or more RF memory tags read by a user device, according to various embodiments;

FIG. 4 is a diagram of a user interface utilized by a merchant for configuring one or more RF memory tags for use in connection with a promotion, according to one embodiment;

FIGS. 5A-5D are ladder diagrams depicting various stages of the process for facilitating processing of promotional/payment information based on one or more RF memory tags read by a user device, according to various embodiments;

FIGS. 6A-6G are diagrams of user interfaces utilized in the processes of FIGS. 3A and 3B, according to various embodiments;

FIG. 7 is a diagram of a user interface utilized by a merchant for reviewing report data pertaining to one or more RF memory tags for use in connection with a promotion, according to one embodiment;

FIGS. 8A-8C are flowcharts of a process for facilitating a purchase transaction based on one or more RF memory tags read by a user device, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

A method and apparatus for processing promotional information (e.g., coupons) based on radio frequency memory tag detection are disclosed. “Promotional information,” may include for example, any data for indicating details regarding a product, good, service or a combination thereof. In addition, promotional information may include, for example, a discount, offer, coupon, incentive or other benefit to be derived by a user in response to execution of a transaction relating to a service, product, good or a combination thereof. The transaction facilitated in connection with the promotion may include a purchase transaction, registration or sign-up procedure, intent-to-buy transaction, referral transaction, event registration, initiation process or the like. As will be discussed more fully, promotional information representing a service, product, good or distributor of such goods may be presented in the form of a symbol, code, text string, audio or video data, etc. It is noted that a radio frequency (RF) memory tag may be captured, or in some instances, read by way of various data capturing or reading tools for acquiring promotional information.

In the following description, for the purpose of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

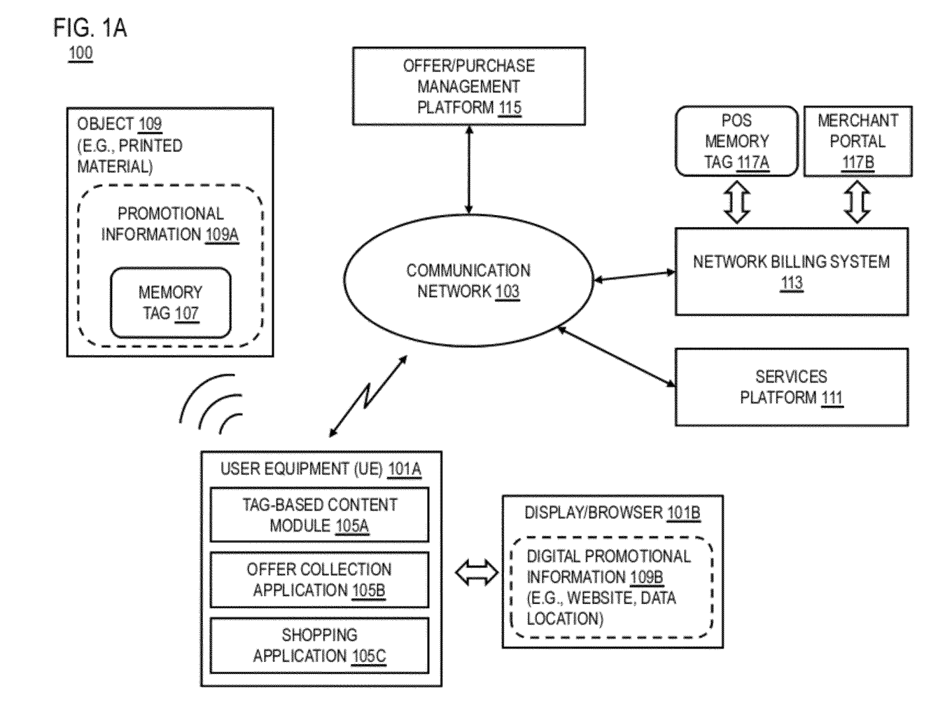

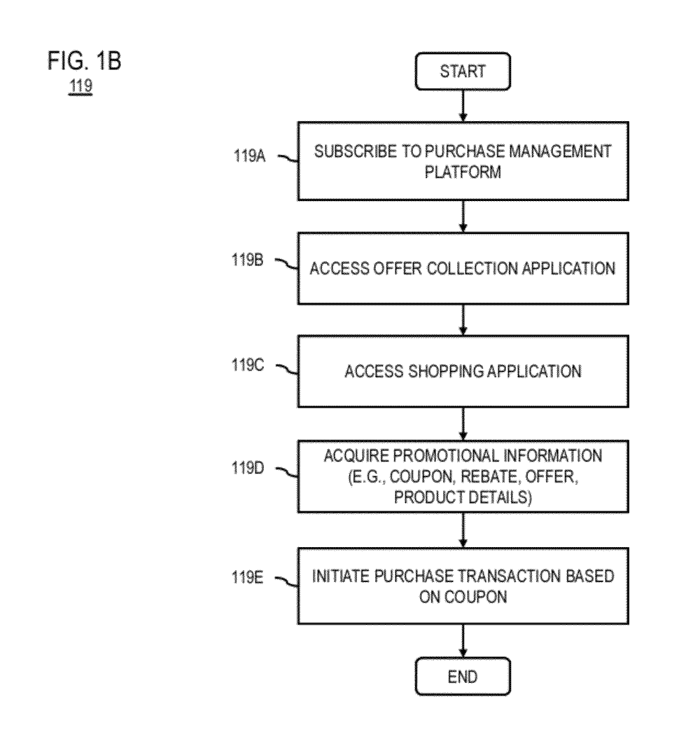

FIG. 1A is a diagram of a system for automatically processing promotional information for use in facilitating a point-of-sales transaction based on the reading or one or more radio frequency (RF) memory tags by a user device, according to one embodiment. The system is configured to enable user devices, i.e., user equipment (UE) 101A to read and/or detect one or more memory tags 107 for conveying promotional information relating to one or more products, goods, services or a combination thereof. A user of the UE 101 is able to then store and catalogue the promotional information for later use, such as in connection with a point-of-sales terminal or network billing system 113 of a merchant for executing a purchase transaction. This configuration enables users to readily maintain, organize, and recall promotional information associated with specific products, goods and services—referred to by way of example as “items” of interest—on demand and/or based on proof of presence information.

In one embodiment, the purchase transaction is facilitated by a purchase management platform 115 based on processing of the promotional information (e.g., coupon), a point of sale identifier, or a combination thereof, independent of a merchant point of sale system. In certain embodiments, the point of sale identifier may include, for example, a barcode such as an International Article Number (EAN) or a Universal Product Code (UPC), a matrix code such as a 2D barcode or Quick Response (QR) code, an alphanumeric or textual identifier value, or a combination thereof. As will be discussed more fully later on, the purchase management platform 115 maintains a virtual wallet for a particular user for storing promotional information and associated point of sale identifiers. The virtual wallet may be a repository for the collection of promotional information and made accessible to a user device (e.g., UE 101A) by way of an offer collection application 105B. In addition, a shopping agent, service or application 105C is provided for execution by the user to facilitate the purchase of a given object 109 or item of interest based on the corresponding promotional information and/or point of sale identifier.

Historically, “merchants” of various forms, including for example service providers, retailers, manufacturers, distributors and other parties responsible for causing the selling of items to users (consumers) have used promotions of various types to induce buyers. By way of example, a promotion provided by a merchant for a particular product may include a buy-one-get-one free offer, a percentage discount offer, free delivery, delayed payment, rebates, trial items, entry into a contest or sweepstakes, accumulation of points of a monetary or non-monetary value or other incentive. In many instances, the promotion may be used within the context of an advertising campaign, wherein the promotional information is presented to users via books, magazines, newspapers, mailers, catalogs, advertisements, billboards, and the like. Internet, e-mail and telephone based mediums may also be employed for providing details of various promotions and incentives. Typically, the user is required to tear out the promotional information (e.g., coupon) or present an offer code to a POS representative (e.g., cashier) at the time of purchase.

As an alternative to printed promotional information, many merchants and service providers employ proof of presence based technology as a means of incenting customers and driving purchase activity. By way of example, merchants and service providers place radio frequency (RF) tags at various locations within sight of mobile device users as a means of enabling product information exchange, transferring coupons and incentives, validating store location visits (e.g., checkins) by users and facilitating purchase transactions. The RF tags may be read by the mobile device using software for detecting, scanning and subsequently decoding information conveyed by the tags as they are affixed to product posters and advertisements or placed near the entrance of a store or point-of-sales (POS) terminal of the merchant or service provider. The software may operate in connection with one or more sensors of the mobile device for detecting the RF signals such that a user need only tap their device against the tag or place it within proximity of the tag to facilitate the reading process.

The use of RF tags promotes more direct user interaction with the merchant, service provider and products and services being offered. Users may use their mobile device to aggregate promotional information regarding several different products and/or services at a given time as they go. For example, a user may aggregate several coupons relating to various products and/or services over time, including those specific to a particular sales campaign, limited time offers (e.g., a cutoff date or time such as a 9 am-5 pm sale), limited to particular store locations, etc. Unfortunately, many merchants and service providers have no system for enabling device users to automatically discover and redeem coupons that are relevant to the merchant at the moment of the point-of-sale—i.e., only those pertaining to the 9 am-5 pm sales event. Furthermore, many merchants are unable to readily adapt their existing POS systems to facilitate the redemption of coupons and incentives captured via one or more tags. They must install additional hardware for connecting to product or service backend systems or install barcode reader software to enable their POS systems to securely interact with mobile devices. This is particularly challenging for smaller merchants who may not have the proper infrastructure, time or capitol to support proof of presence capabilities.

The system 100 of FIG. 1A addresses this problem by associating promotional information captured by a mobile device via an RF memory tag with determined point-of-sales activity. The RF memory tag 109 has sufficient memory to store promotional information (e.g., text, video, still pictures, voice media, databases, documents, software, purchasing data, product data, store data, inventory information, etc.) about its associated item. By way of example, only the promotional information that is determined relevant to the present product, time, date, sales promotion, user, store location or other factors may be recalled for processing to facilitate the point-of-sale by the merchant. Under this approach, point-of-sales activity is determined to occur upon the reading of a POS memory tag 117A by the mobile device through which the various promotional information (e.g., coupons) have been aggregated. Reading of the tag may be facilitated through physical activation of memory tags, including tagging, touching or other contact bay a tag processing capable device or via a proximity/presence detection capability of the device (e.g., near field communication).

In other embodiments, as another means of enticing consumers, many merchants employ proof of presence based marketing and incentive provisioning techniques. Proof of presence, by way of example, includes various techniques for triggering the activation of promotional information (e.g., retrieval or redemption of a coupon) based on the determined physical presence of the user at a designated location. Hence, under this scenario, promotional information may directly linked to a particular merchant, merchant location, venue, etc. Typically, verification of a user's presence at the designated location is performed by way of various presence detection techniques, including near field communication and radio frequency identification (RFID) memory tag use. RFID memory tags may be affixed to or near the product for being detected by a mobile device of the user as they are physically present at the designated location. In other instances, the memory tags may be used in conjunction with other data capture techniques to initiation the promotional information capture or usage process, including the capturing of an image of the product, entry of a barcode or product identifier, etc.

Upon detecting the presence of the user, additional steps must be executed in order to facilitate a purchase transaction. For example, the user may redeem the coupon by interfacing with the merchant's point-of-sales (POS) system, i.e., presenting the display of their device to an operator at a POS terminal. Additional steps may also be performed by the operator including the entry of a verification code, reconciling of the coupon against the specific product, security clearance procedures, etc. Still further, the actual purchase of the product in accordance with the tenets of the promotional information requires execution of the POS terminal, including credit card billing, checking account verification, membership verification (e.g., preferred shopper), etc. Unfortunately, the number of incremental steps required to fully execute the consumer purchase transaction is cumbersome to the user. Furthermore, the dependency on a POS system any other dedicated device on the part of the merchant to facilitate the purchase transaction limits the overall effectiveness of proof of presence based incentive execution.

In some embodiments, the system 100 of FIG. 1A addresses this additional problem by enabling users to seamlessly execute a purchase transaction based on the data read from, or associated with an RF memory tag. Data read from an RF memory tag 107 may include promotional information such as a coupon, incentive, product details, etc. Reading of a tag 107 may be facilitated through physical activation, including tagging, touching, tapping or other contact by a tag processing capable device 101A or via a proximity/presence detection capability of the device 101A (e.g., near field communication). An RF memory tag 107, as associated with a particular item (object) 109, has sufficient memory to store promotional information 109A (e.g., text, video, still pictures, voice media, databases, documents, software, purchasing data, product data, store data, inventory information, etc.) regarding the associated item.

By way of example, a memory tag 107 associated with a magazine article advertising a particular product and/or service will be linked to a website featuring additional or other promotional information and/or other details regarding that product and/or service. The website may be implemented with respect to a marketing or advertising campaign pertaining to the offer, items for purchase or merchant, wherein the promotional information is developed by the merchant or affiliates thereof. By linking to a specific location, the memory tag 107 and associated promotional information 109A serves as a gateway to offer contextually relevant campaigns and/or coupons to the user—i.e., as digital promotional information 109B. Upon acquiring and subsequently storing this digital promotional information, the information can be automatically retrieved at the point-of-sales terminal for use in securing the product or service by reading of the POS memory tag 117A.

It is noted that the memory tags 107 may be supplied to the merchant by the various affiliates to which the merchant interacts. For example, the merchant may function as a distribution channel, retail outlet, vendor or the like that is affiliated with multiple different service and goods providers reliant upon the merchant to distribute their products. Under this scenario, the different affiliates supply the merchant with various memory tags 107 or tagged posters, banners and other objects 109 for enabling user device activation of promotional information 109A. The objects 109 may correspond to a particular marketing and/or promotional campaign of the provider, and may include for example a poster for placement at various locations throughout a shopping mall, placement at the entrance of the store location, for placement at select locations within the store, at the POS terminal, for placement within an elevator or public transportation advertisement space, etc. As noted, the memory tags 107 supplied may be configured to enable activation/presentment of place information at a UE 101A, where the place information corresponds to a respective affiliate of the merchant. Hence, device users are able to access a wide variety of advertisements, promotions, coupons, incentives as digital promotional information 109B by way of the memory tag 107. In certain instances, the memory tag 107 may be directly affixed to the service, product or good that is to be purchased. Hence, the object 109 may correspond to the item to be purchased.

In addition, POS memory tags 117A are uniquely assigned to a specific merchant for enabling point-of-sales transactions to be readily carried out based on the promotional information supplied by the various memory tags 107. By way of example, the POS memory tag may be read by the user's mobile device at the POS terminal in order to convey the most relevant coupons the user has available for carrying out an item purchase to the merchant (e.g., POS clerk). As the user accumulates various promotional information by touching/contacting different RF memory tags, i.e., at a store location, the promotional information pertaining to the various items is automatically input. This may include, for example, presentment of the appropriate promotional information to a POS terminal display, loading of user profile information, validation processing, etc.

The system 100, in certain embodiments, also includes an offer/purchase management platform 115 that is configured to manage promotional information as provided by one or more merchants for use by a user of UE 101A. The offer/purchase management platform 115 also enables interaction between a merchant and the user devices based on reading of one or more memory tags (e.g., 107, 117A). By way of example, the offer/purchase management platform 115 interacts with UE 101A to store the various promotional information read by the device on behalf of the user, i.e., as a virtual wallet. In addition, merchants as well as providers of goods and services may access the offer/purchase management platform 115 in order to define and configure promotional information. Hence, the offer/purchase management platform 115 acts as an intermediary service between the device user, merchant and/or service providers who offer various items for purchase. Under this approach, the offer/purchase management platform 115 is configured to interact with an existing merchant point-of-sales system to enable the reading and subsequent immediate retrieval of a user's promotional information (e.g., coupons) based on the detection of a POS memory tag 117A. Retrieval of the promotional information from the platform 115 is context based—i.e., context relevant proof of presence transactions are carried out with respect to time, date, product, user, store location, etc. In certain embodiments, physical position and/or location of the device may also be accounted for, such as that determined based on global positioning system (GPS) or local positioning system (LPS) techniques. As will be discussed more fully later on, the offer/purchase management platform 115 maintains a repository of promotional information (e.g., coupons) in connection with a user as said promotional information is retrieved by a user device, i.e., a virtual wallet for later redemption. The promotional information may be configured for use and sharing with various users by merchants through a merchant portal 117B—i.e., a website or web service accessible by respective merchants for detailing and establishing offers. It is noted that in certain embodiments, the offer/purchase management platform 115 is implemented as a hosted solution or according to a cloud computing infrastructure by a service provider. As a hosted or cloud based solution, the offer/purchase management platform 115 may be integrated for use by a merchant through communication interface means, but without requiring the adaptation or installation of significant hardware or software systems.

In one embodiment, a user device (e.g., a mobile device equipped with a tag reader and/or writer, mobile reader/writer) detects the RF memory tag associated with an item, reads the promotional information from the RF memory tag and initiates communication with the offer/purchase management platform 115. A tag-based content module 105A facilitates the necessary functions for enabling reading of memory tags 107 as well as for interpreting promotional information, completing a purchase, and/or making payment. In certain instances, the tag-based content module 105A may also be configured to initiate execution of a portal application or browser 101B to the display of UE 101 in response to interpreting promotional information indicative of a data resource, website, etc. The display/browser 101b presents digital promotional information 109B to the user.

Also operable on the UE 101A in connection with the offer/purchase management platform 115 is an offer collection application 105B. The offer collection application 105B is a native or web-based application and/or service that facilitates the downloading, viewing, sharing and redeeming of coupons, incentives and other forms of promotional information. By way of example, when the display/browser 101B of UE 101A presents digital promotional information 109B, including one or more coupons or gift certificates as provided by a merchant, the offer collection application 105B enables downloading of such information to a repository (virtual wallet) associated with the user of UE 101A or to a local data store. It is noted that the offer collection application 105B may store all promotional information (e.g., coupons) as presented to the display of the UE 101B in connection with the reading of a memory tag 107, a portion of the promotional information (e.g., most recent coupons), present the promotional information in conjunction with the offer/purchase management platform 115 (e.g., call for coupons when required or when certain criteria is met), or a combination thereof.

In one embodiment, system 100 also enables users to facilitate registration, purchase, enrollment and other transactions with a merchant in connection with the promotional information 109A or 109B associated with a given memory tag 107. For example, when a user is reading a printed catalog that features promotional information regarding a product as well as an embedded RF memory tag, the user can detect the RF memory tag (e.g., as affixed to various pages of the catalog) with the tag reader (module 105A). Upon reading, the user is able to interpret the promotional information from the respective tag 107, download it, view it and store it to the repository for later redemption. Alternatively, the user is directed to digital promotional information 109B relating to the item of interest. When the user further tags a POS memory tag 117A, which is located at a point-of-sales system or network billing system 113 of the merchant, the various coupons pertaining to the item to be purchased are recalled and presented to the device display. Factors that affect use of the promotion information, including time, date, location/position (e.g., GPS coordinates) and other data, is tracked and processed to ensure only the most relevant coupons are recalled for use in facilitating the transactions.

It is noted that execution of the offer collection application 105B in conjunction with the offer/purchase management platform 115 enables efficient, seamless accessing and correlation of specific promotional information with a given user. By tapping a POS memory tag 117A, UE 101 of a given user is caused to display the exact offers to which the user is entitled based on the contents of their virtual wallet (e.g., repository as maintained by the offer/purchase management platform 115) as it corresponds to the merchant. The process of retrieving promotional information is facilitated by a triggering mechanism (tag based or proximity based communication) rather than through performing multiple clicks at a website or other application for housing such information. This approach to facilitation of coupons and other offers presents advantages to the merchant, affiliates thereof and device user, including streamlining the execution of promotions, facilitating enhanced campaign management and offer usage tracking, active and/or physical engagement of device users in promotions and other advantages. In addition, the process of validating the coupon and verifying proof of presence is performed at the user device in connection with the POS terminal; thus enabling execution of system 100 to be integrated with any type of POS system.

FIG. 1B is a flowchart of a process for initiating a user device to enable a purchase transaction based on one or more radio frequency (RF) memory tags, according to one embodiment. By way of example, steps 119A-119C of process 119 represent pre-conditional processes required to be performed by one or more elements of system 100 for enabling the above described operations. In step 119A, a user and/or user device subscribes to the purchase management platform 115. In this way, the user and associated UE 101A of the user is recognized by the purchase management platform 115 for maintaining specific promotional information for that user (e.g., a virtual wallet). The subscription process may include the generation of a user profile, a device profile, a menu of participating merchants to which the user may prefer to shop, etc.

In another step 119B, the shopping application 105B is accessed by UE 101A, i.e., downloaded or linked to a cloud infrastructure/resource, such as during the time of initial subscription to the purchase management platform 115. Per step 119C, the shopping application 105c is also accessed by the UE 101A. In certain embodiments, the shopping application 105C is downloaded to the UE 101A or callable for execution via a link to the cloud infrastructure/resource during the time of initial registration—i.e., when the user indicates preferred shopping locations. Alternatively, the shopping application 105C may be downloaded or accessed at the time of a user visit to a particular merchant location, i.e., a store location. This may be triggered automatically based on determined proof of presence via near field communication, or as a result of tapping of a memory tag 107 at the merchant location for accessing promotional information 109A pertaining to an object 109 of interest.

Upon completion of steps 119A-119C, the user is then able to acquire promotional information 109A per step 119D. This includes digital promotional information 109B as presented to the display/browser 101B as well as promotional information 109A captured from the reading one or more memory tags 107 by the tag-based content module 105A. It is noted, therefore, that promotional information (e.g., a coupon) can originate from any digital or physical source, including a banner advertisement, poster, website, simple messaging service (SMS) message, multi-media messaging service (MMS) message, Bluetooth data transfer, near field communication (NFC) peer-to-peer transfer, server application, mobile application, secure wallet application on the mobile device or a 2D or standard barcode scanned with the camera of the mobile device. In the case of digital promotional information 109B, as garnered from a website or data location, the electronic coupon may feature a unique code for the corresponding coupon type. It may also indicate details regarding type of discount/offer, brand and designated locations where the coupon can be redeemed for proof of presence purposes.

Per step 119E, the user is able to initiate a purchase transaction based on the acquired promotional information. This includes, for example, accessing the required promotional information from the virtual wallet, applying the promotional information (e.g., discount) to the transaction and executing payment with respect to a network billing system 113 based on said promotional information. In certain instances, delivery of the object 109 may also be coordinated in connection with the purchase. These executions are facilitated by the purchase management platform 115 independent of the use of devices and systems executed by the merchant such as credit card processors, cash registers, etc. A third-party network billing system 113 and services platform 111 may also be accessed by the platform 115 to enable payment fulfillment and proof of presence execution independent of a particular merchant.

As shown in FIG. 1A, system 100 comprises a user equipment (UE) 101 having connectivity to a communication network 103. The UE 101 is any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, digital camera/camcorders, audio/video players, positioning devices, game devices, televisions, and/or the like, or any combination thereof. It is also contemplated that the UE 101 can support any type of interface to the user (such as “wearable” circuitry, etc.) and includes a RF memory tag reader, a camera, or other similar input/output (IO) component. The UE 101 includes a tag-based content module 105 to enable interaction with a RF memory tag 107 associated with an object 109 (e.g., printed media) as described herein. For the purpose of example, the UE may be referred to synonymously with a user device (e.g., wireless communication device).

In various embodiments, the RF memory tag 107 is a near field communication (NFC) tag, radio frequency identification (RFID) tag, contactless card, a wirelessly powered RF memory tag, or the like that includes sufficient memory to store promotional information related to the object 109 to which it is affixed (e.g., a bill board, banner, etc.). It is contemplated that the RF memory tag 107 may also be any similar wirelessly powered RF memory tag. The RF memory tag 107, for instance, is associated with (e.g. embedded in, attached to, or printed on) any of a variety of objects capable of supporting the tag (e.g., packaging material, a sticker, a poster, a card, a magazine, a newspaper, products, clothing etc.). For example, a RF memory tag 107 associated with a clothing may provide laundry instructions or links to local dry cleaners, as well as a promotion for discounted cleaning services. As another example, a RF memory tag 107 associated with printed media, whether physically or digitally rendered, may include links for downloading a presentation, audio file or other media file in connection with a promotion, campaign, marketing scheme, etc.

By way of example, NFC, RFID, contactless card, and similar technologies are short-range wireless communication technologies that enable the exchange (e.g., both reading and writing) of data between devices and tags over short distances (e.g., the range for NFC is approximately 4 inches). In general, these technologies comprise two main components, a tag (e.g., attached to an object) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials.

Moreover, the tags may be passive tags or active tags. Passive tags are generally smaller, lighter, and less expensive than active tags. Passive tags are only activated when with the response range of a reader/writer. In other words, passive tags are typically RF memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the RF memory tag 107 can, for instance, enable the system 100 to write comments for storage in the RF memory tag 107 for retrieval by other users or update the content of the RF memory tag 107 to include the latest content. For example, a RF memory tag 107 associated an advertisement can be updated to contain the latest pricing and availability information.

A reader/writer typically contains a transmitter, receiver, control unit, and an antenna. In addition, the reader/writer may also feature several bytes (e.g., gigabytes) of non-volatile memory such as phase changed memory (PCM) or the like for maintaining data. The reader/writer performs several primary functions: energizing the tag, demodulating and decoding the returned radio signal, and providing clock information. In certain embodiments, a reader/writer includes an additional interface to convert the returned radio signal to a form that can be passed to another system such as a computer or programmable logic controller. As discussed previously, the RF memory tag 107 may be decoded and interpreted to reveal information regarding the object 109 including text, videos, pictures, audio files, databases, documents, software, and the like for promotional purposes. In certain embodiments, the promotional information also includes links, pointers or reference data to web based content; thus enabling the RF memory tag 107 to reference dynamically updatable content such as a web page that provides time sensitive information, real-time data, dynamically driven data or the like.

This approach also extends to enablement of point-of-sale (POS) memory tag, which is used by merchants to facilitate coupon redemption. In addition, the POS memory tag is used to immediately associate/link a POS transaction by the merchant with the promotional information captured by the device. In certain embodiments, the POS memory tag 117A is a static RF memory tag that has a unique identifier value and signature assigned to it. The identifier (ID) is registered with the offer/purchase management platform 115 to a specific merchant, and is further assigned by the merchant to a specific POS terminal/system (e.g., network billing system 113). Upon being read by a tag reader/writer, the POS memory tag 117A links to a merchant portal 117B that features a coupon redemption user interface (UI). The merchant portal 117B may or may not be linked to the website from which the user received the digital promotional information 109B.

As with the memory tag 107, it is noted that the POS tag 117A may store information that includes a hyperlink, URL, URI, IP address or other location information for accessing the digital promotional information 109B, the merchant portal/coupon redemption application, or both. The coupon redemption application can be maintained remotely or at a computing device of the merchant/retailer wherein the POS tag is located—i.e., by way of a network billing system 113 of the merchant or services platform 111.

In exemplary embodiments, the services platform 111 provides services to support actions that may be related to the promotional information contained in the RF memory tag 107, POS memory tag 117a, or a combination thereof. Such actions may include providing access codes to the RF memory tag 107, registering a user, purchasing items, downloading software, enabling merchants to configure memory tags and related promotional information, etc. In certain embodiments, the services platform 111 also interacts with the network billing system 113 to coordinate payment and billing for the services. The network billing system 113 may include or is associated with a point-of-sales terminal (not shown), which may include equipment for scanning item codes and barcodes, inventory management systems, cash management features, etc. When a user engages a purchase transaction, the network billing system 113 carries out the billing process on behalf of the user with various third party payment providers, i.e., credit card service providers, banks, etc. It is contemplated that the services platform 111, network billing system 113 and offer/purchase management platform 115 may be operated on the same platform or service.

In certain embodiments, data associated with the RF memory tag 107 for carrying out the purchase transaction may include a point of sales identifier, such as a barcode that is related to the object 109 to be purchased. It is noted in certain embodiments that the point of sale identifier may be interpreted/detected by reading of the RF memory tag 107, i.e., encoding of an EAN as part of the set of promotional information 109A regarding the object 109. Hence, reading of the identifier is a particular means of associating the object 109 to which the POS identifier pertains with the promotional information 109A. Alternatively, an object 109 may be associated with the promotional information 109A to facilitate its purchase by way of one or more of the following techniques of TABLE 1 below:

TABLE 1

| | |
|---|---|
| a. | Capturing an image of the object 109 of interest using a camera of the user |
| | equipment 101A; and using image recognition to recognize the object 109 against |
| | a product catalogue/database maintained by the purchase management platform 115; |
| b. | Capturing an image of the point of sales identifier (e.g., EAN) using a camera of |
| | the user equipment 101A; and using image recognition to recognize the POS |
| | identifier against a product catalogue/database maintained by the purchase |
| | management platform 115; |
| c. | Capturing an image of the product name of the object 109 using a camera of the |
| | user equipment 101A; and using image recognition to recognize the name against |
| | a product catalogue/database maintained by the purchase management platform 115; |
| d. | Capturing text data representative of the point of sales identifier (e.g., EAN) using |
| | a virtual or hardware keyboard; and submitting the text data to a purchase |
| | management platform 115 for comparison against a product catalogue/database; |
| e. | Capturing voice data representative of the point of sales identifier or product |
| | name by way of a microphone of the user equipment 101; and using voice/sound |
| | recognition (e.g., Vlingo) to recognize the POS identifier or product name against |
| | a product catalogue/database maintained by the purchase management platform 115. |

For the above mentioned techniques, the purchase transaction process is carried out by the purchase management platform 115 at the discretion of the user of UE 101A based, at least in part on an association between an object 109 to be purchased, a point of sale identifier associated with the object 109, promotional information 109A pertaining to the object 109, or a combination thereof. Various other means of performing such an association within the context of a proof of presence scheme may also be implemented accordingly.

In certain embodiments, the purchase management platform 115 provides various functions for enabling the facilitation of a purchase transaction based at least in part on the promotional information, point of sales identifier, or a combination thereof. Purchase processing is performed in connection with a shopping application 105C that provides an interface to the purchase management platform 115. The shopping application 105B is a native or web-based application and/or service that is executable by the user equipment (UE) 101A and includes various application programming interfaces (APIs) for interacting with the operating system (OS) of the UE 101A. By way of example, the shopping application 105C renders to the display of the UE 101A user controls for selecting products and/or services of interest, managing a shopping cart or executing a purchase. In addition, the shopping application 105C is merchant specific, such that the user may purchase products of interest based on determined proof of presence relative to a designated location of the merchant.

By way of example, the shopping application 105C may be downloaded to or caused to be displayed to (e.g., via a browser application or as web service) UE 101A by the purchase management platform 115. The shopping application 115A may feature one or more logos, designs and other features specific to the merchant—i.e., color schemes and affiliated insignia of the merchant to which an object 109 of interest is to be sold. In addition, the shopping application 105C may be configured to receive input for identifying a particular object 109, including for example, point of sales identifier data or other data for identifying the object 109 as discussed with respect to TABLE 1. Consequently, when the user calls or triggers the application 105C to shop with the merchant at a designated location, the shopping application provides notification to the purchase management platform 115 of the following: (1) a user associated with a specific device and/or user profile as maintained by the purchase management platform is ready to shop; (2) payments for goods must be directed to a specific merchant associated with a specific merchant profile maintained by the purchase management platform 115.

It is noted that the goods capable of purchase via the application 105C correspond to those specified in a product catalogue/database maintained by the purchase management platform 115. Also, the profiles of the user, device and merchant may include, among other data, a unique user identifier, device identifier and merchant identifier respectively for distinguishing among a plurality of users, devices and merchants the purchase management platform 115 may interact with. In addition, the shopping application 105C may operate in conjunction with an offer collection application 105B that provides access to the virtual wallet of the user. As such, the offer collection application 105B enables redemption of select promotional information for execution of purchase transactions.

As shown in FIG. 1A, the UE 101 has connectivity to the offer/purchase management platform 115, services platform 111 and network billing system 113 through a communication network 103. By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), wireless personal area network (WPAN), short range radio networks, and the like.

By way of example, the UE 101 communicates with the other devices or components (e.g., the offer/purchase management platform 115) on the communication network 103 using standard protocols. In this context, a protocol includes a set of rules defining how the network nodes within the communication network 103 (e.g., UE 101 and services platform 111) interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination/address, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

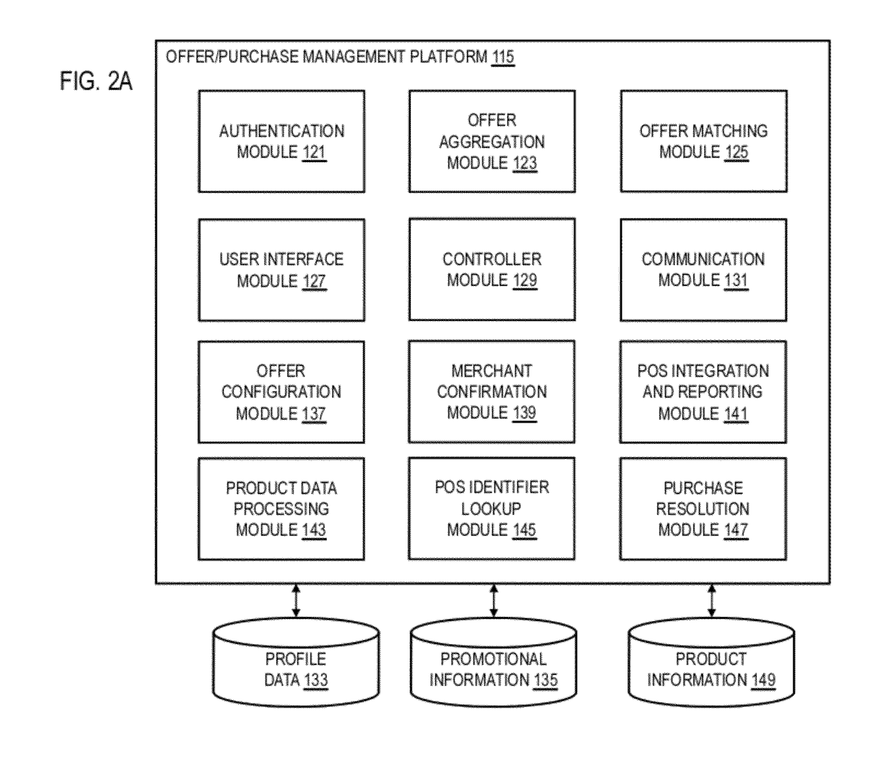

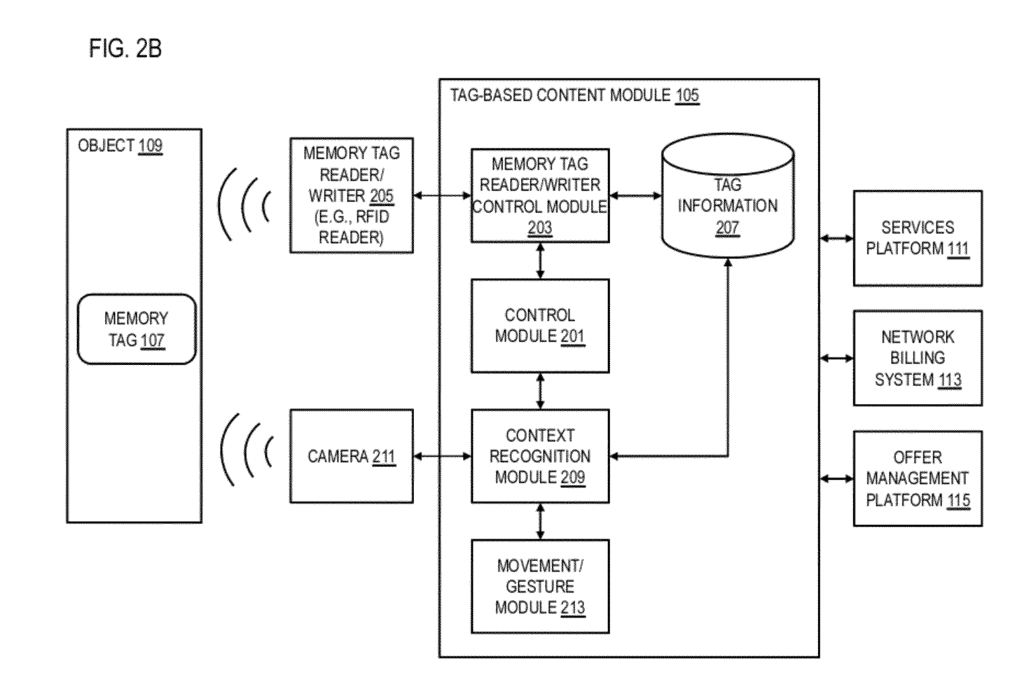

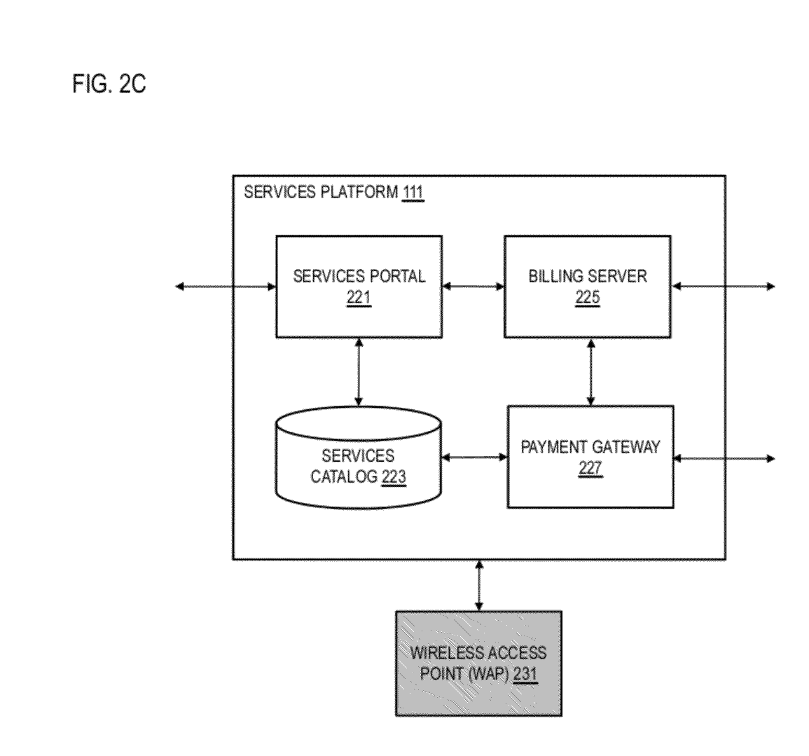

FIG. 2A is a diagram of components of an offer/purchase management platform, according to one embodiment. The offer/purchase management platform 115 includes various executable modules for performing one or more computing, data processing and network based instructions that in combination provide a means of facilitating processing of promotional information based on one or more RF memory tags read by a user device. The modules can be implemented in hardware, firmware, software, or a combination thereof. By way of example, the offer/purchase management platform 115 includes an authentication module 121, offer aggregation module 123, offer matching module 125, user interface module 127, controller module 129, communication module 131, offer configuration module 137, merchant confirmation module 139 and POS integration and reporting module 141.

In addition, the offer/purchase management platform 115 also accesses profile data from a profile database 133 for storing user profile data as well as a promotional information database 135 for maintaining data regarding one or more promotions offered by one or more merchants. It is noted that access to promotional information by users may vary (e.g., show part, all or none) based on privacy rules and access credentials as specified per the user's profile. By way of example, a specific offer having been assigned an Offer Identifier may be linked to a specific user profile that is assigned a specific User Identifier value. The profile data 133 will also maintain a history of user redeemed offers. By way of this approach, the authentication module, offer aggregation module and user matching module can account for redeemed offers.

In one embodiment, an authentication module 121 authenticates user equipment 101A for interaction with the offer/purchase management platform 115. By way of example, the authentication module 121 receives a request to subscribe to the service, as provided by a wireless communications service provider, for enabling the recall of prior stored promotional information 135. Under this scenario, the authentication module 121 verifies and validates a password, user identification number, security code or any other value required for enabling access to the specific promotional information pertaining to the user. It is noted that the authentication module 121 may access profile data maintained for respective users (subscribers), including the selective recalling, pulling or searching of profile data 133 associated with a given user device that reads a RF memory tag.

In one embodiment, an offer aggregation module 123 maintains one or more coupons, offers, promotional items, etc. as accumulated by a particular user in response to UE 101 reading or detection of one or more memory tags 107. The aggregation module 123 may facilitate organization of the promotional information 135 pertaining to a specific user as one or more directories, each directory categorized by a user, merchant, or a combination thereof, for organizing the one or more promotional items. In addition, the module 123 operates in connection with a communication module 131 for enabling a user to view the coupons available to them via the display/browser 101B of their UE 101A as well as initiate redemption of a coupon. Coupons are presented to the user as a “wallet” with respect to profile data 133.

Also, in one embodiment, an offer matching module 125 matches the promotional information detected from reading of a memory tag 107 by a user device with a specific set of promotion data 135 (e.g., campaign data). The offer matching module 125 is also configured to parse through the promotional information 135 as aggregated to match coupons/offers with a point-of-sales transaction at the present moment. By way of example, the memory tag 107 can link the UE 101A to a server side component or a local application (e.g., merchant portal 117B or browser application 101B) for enabling access to other promotional content. In another example, when a tag is read with respect to a specific promotion corresponding to a promotion identifier, for a specific item and merchant corresponding to a item and merchant identifier, for a specific user corresponding to a unique user identifier, for a specific time or date; the offer matching module 125 facilitates the lookup of matching identifiers and/or information in the promotional information database 135.

In certain embodiments, the matching process performed by the offer matching module 125 is facilitated based on user profile information, content information, or contextual information. Hence, a user (e.g., frequent shopper with a known identifier) of UE 101 can be matched with a preferred shopper discount provided by a merchant, having a known offer and merchant identifier respectively. Both the profile data 133 and promotional information 135 include one or more identifiers for enabling the lookup and referencing of specific data. As another example, a coupon relating to a limited time sale may be rejected for selection or use in facilitating a POS transaction based on a determination that a time has expired. Still further, an offer for use at a specific store location may be prevented from activation due to a determination that the user is not at that location. It is noted that the offer matching module may employ the use of various internal sensors and/or services related thereto for facilitating matching with respect to a POS transaction. This may include GPS sensors, position/orientation sensors, clocks, etc., for collecting data which may be useful for enabling proof of presence verification as well.

The offer matching module 125, in connection with the user interface module 127, also causes presentment of the campaign details via the merchant portal 117B for facilitating the purchase transaction at the POS in response to reading of a POS memory tag 117A. This includes determining, based on the matching process, the final calculation of a coupon matchup with an active promotion. Based on the determined calculation/match, the offer matching module 125 prompts the user interface module 127 to display the final recommended discount, such as the final cost of a product with an applied 20% discount.

The offer matching module 125 is also configured to handle execution of the offer/purchase management platform 115 in instances where no coupon was selected before the user of UE 101a taps the POS memory tag 117A. By way of example, the offer matching module 125 matches the best available offer combination from the user's wallet, i.e., as maintained as promotional information for a user in connection with a particular user profile 133. Under this scenario, the deal matching module 125 may cause selection of a coupon or deal that is substantially close to a current offer, i.e., enable a 5% discount coupon as opposed to the 10% discount that the user lacks a coupon for.

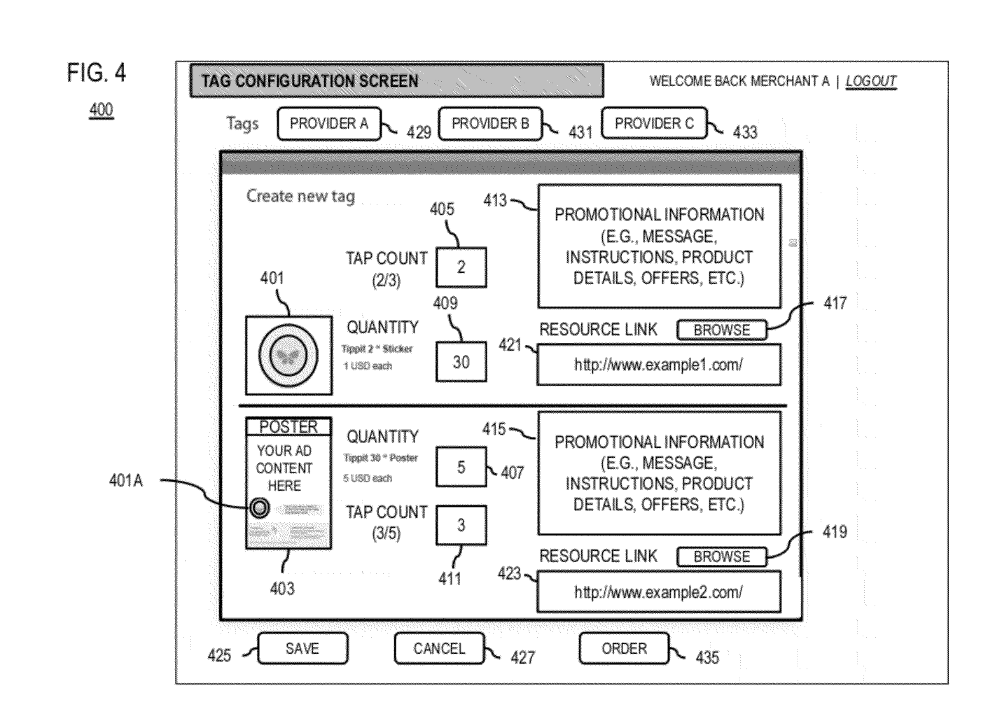

In one embodiment, the user interface module 127 enables presentment of data to a graphical user interface of UE 101. Various software applications operable by the UE may feature APIs or other function calls corresponding to the user interface module 127 for enabling graphical elements to be displayed by the device as well as digital promotional information 109B. The user interface module 127 is configured to generate signals for causing execution of these APIs or functions calls at a display 101B of UE 101A, at a merchant portal 117B of the merchant network billing system 113 and/or POS terminal, or a combination thereof. As will be discussed more fully with respect to FIGS. 4, 6A-6G and 7, the user interface module 127 enables the presentment of promotional information, configuration and detail information, instructions and the like. For example, the user interface module 127 is configured to enable presentment of a configuration interface via the merchant portal 117B in conjunction with an offer configuration module 137 for receiving offer input data from one or more merchants. The user interface module 127 also enables users to view the contents of their wallet, as well as the sharing of the contents of the wallet at the POS terminal, i.e., responsive to touching of a POS tag by the UE 101. As such, a user of the POS terminal may view the applicable offer redemption information (e.g., coupons) as is available to the user via the display 101B of the UE 101A.

In certain embodiments, the offer configuration module 137 operates in connection with the user interface module 127 to generate the merchant portal 117B. By way of example, the offer configuration module 137 receives promotional information 135 from one or more merchants—the promotional information being entered or uploaded by way of a user interface of the merchant portal 117B. The promotional information 135 may be packaged according to a particular format based on a common data entry process by merchants who access the portal 117B.

The merchant confirmation module 139, in certain embodiments, enables further confirmation steps to be performed beyond the point of offer matching and validation by the offer matching module 125. The confirmation steps include those to be performed by the operator of the POS terminal, by a billing and payment services provider, by a security agent operating in connection with the POS terminal, or a combination thereof. For example, the merchant confirmation module 139 operates in connection with the user interface module 127 to cause presentment of a redemption verification screen at the merchant portal 117B. Under this approach, the operator is required to enter a verification code for allowing execution of the offer. In another example, the merchant confirmation module 139 enables a web application that monitors the activity of a specific POS tag or performs a verification sequence with the user equipment using NFC.

In one embodiment, the POS integration and reporting module 137 enables the offer/purchase management platform 115 to interact directly with the POS terminal. By way of example, the POS integration module 141 can be configured to generate various control signals for affecting operation of the POS terminal (e.g., halting execution, tracking a purchase) in response to the activation of a POS memory tag 117A by UE 101A. Conversely, the POS terminal may communicate with the POS integration and reporting module for conveying data regarding purchases made in relation to an offer. This may include causing generation of a report containing data, metrics and statistics—for use by a merchant, retailer, service provider, distributor, etc.—for indicating the effectiveness of an offer, coupon, advertising campaign, marketing and/or development effort, etc. Inventory data and financial data can also be maintained and reported.

In one embodiment, a controller module 129 is configured to regulate the communication processes between the various modules. For example, the controller module 129 generates the appropriate signals to control the execution of a communication module 131, which provides the necessary interfaces for transmitting data over the communication network 103. In one embodiment, the communication module 131 also enables formation of a session over the network 103, such as for execution of a browser application of a user device. By way of example, the communication module 131 executes one or more protocols and data sharing techniques for enabling collaborative execution between respective user devices (e.g., mobile devices, laptops, smartphones, tablet computers, desktop computers) and the offer/purchase management platform 115 over the network 103.

In one embodiment, to further match products associated with a read memory tag with a product and a given set of promotional information 135, in certain embodiments, the offer matching module 125 operates in connection with a product data processing module 143 and POS identifier lookup module 145. The product data processing module 143 performs various recognition techniques based on input provided by UE 101A. By way of example, the product data processing module 143 performs image recognition of captured image data related to an object associated with a purchase. This may include determining/matching the image data against the data in the product information database 149. The image data may be of the object itself, a point of sale identifier, or a combination thereof. In the case of a POS identifier being captured, the POS identifier lookup module 145 is executed to determine the specific product corresponding to the POS reference.

As another example, the product data processing module 143 may process text or sound data captured by the UE 101A and match the data against the product information database 149. In the case of the sound data, it may be audio data as spoken by a user of UE 101A that is representative of the object itself (e.g., a description, keyword, product name, model number, marketing term), a point of sale identifier, or a combination thereof. In the case of a POS identifier being captured, the POS identifier lookup module 145 is executed to determine the specific product corresponding to the POS reference. Similarly, the text may be alphanumeric data entered manually by the user for representing the object, a point of sales identifier, or a combination thereof.

It is noted that UE 101A captures the above described data types by way of one or more integrated capturing tools and utilities. The capture tool, i.e., camera, recorder, keyboard, may be called upon for execution by UE 101A in response to the various controls and features of the shopping application 105C. In certain embodiments, the shopping application is able to be rendered to the display of a user device by way of the user interface module 127 and communication module 131. Alternatively, processing of the image, audio or text data pertaining to the product may be performed at UE 101A and subsequently transmitted to the offer/purchase management platform 115. Linking of the captured data along with reading of the RF memory tag facilitates a proof of presence based purchase transaction.

In one embodiment, the purchase resolution module 141 receives a notification from the user (via the authentication module) for indicating activation of a purchase transaction for a given product (e.g., object 109) of interest in relation to specific promotional information. Based on this notification, the purchase resolution module 141 operates to resolve or reconcile the various received input data against the promotional information associated with reading of the RF memory tag. This process ensures payment processing is performed securely and independently via a services platform 111, while in connection with the appropriate merchant, product and promotional information to be applied. It is noted that the offer matching module 125, product data processing module 137 and POS identifier lookup module 139 may operate in tandem or in conjunction with the purchase resolution module 141 to properly validate and resolve the various details required to facilitate the purchase transaction. By way of example, the purchase resolution module 141 resolves, reconciles or validates the following: (1) the name of the company to receive the payment; (2) the final purchase price of the product; (3) the name/identity of the product; (4) the user who is purchasing the product.

With regards to the first item of resolution (1), the purchase resolution module 147 validates that the merchant identifier as specified via the shopping application matches that maintained as profile data 111 relative to the given product, user and/or promotional information (e.g., campaign, sales event, first time buyer incentive). For the second item of resolution (2), the module 147 validates the final price of the product, including all applicable fees, taxes and surcharges, relative to the given product, user and/or promotion information to be applied. The resolution may also include accounting for delivery, credits or cash back incentives accrued to a client account, or other factors. For the third item of resolution (3), the module 147 validates that the promotional information is being applied to the correct product based on the POS identifier and/or corresponding product information 149. Further resolution based on the POS identifier may include resolving the model, type, color, features, equipment manufacturer, serial number, product build, country of manufacture, and other details. Such detail may be referenced by the POS identifier in the product information database 149. Per resolution item (4), the module 147 validates that the purchase transaction is facilitated in connection with the proper user identifier as maintained in a user profile in database 133. This may include the performance of one or more security and user validation protocols and preferences, including for example, validating a subscriber identity module (SIM) card against known records, requiring entry of a login name and password, processing of a fingerprint by way of an image recognition process, or the like.

Of note, the above described resolutions (1-4) are performed by the purchase resolution module 147 in preparation for a purchase transaction in the context of proof of presence scheme. Execution of the purchase is facilitated in connection with the services platform 111 and network billing system 113 while facilitation of proof of presence is based, at least in part, on the reading of one or more RF memory tags, near field communication techniques, etc.

FIGS. 2B and 2C respectively are components of a tag-based content module and a services platform, according to various embodiments. As shown in FIG. 2B, the tag-based content module 105 includes several sub-modules to enhance the object 109 with additional information from the RF memory tag 107. It is contemplated that the functions of the sub-modules may be combined or performed by other components or logic of the UE 101. In exemplary embodiments, the tag-based content module 105 includes a control module 201 for directing interaction with the RF memory tag 107 for obtaining promotional information related to the object 109. The module 201 may, for instance, interact with a RF memory tag reader/writer control module 203 to detect user input for selecting the RF memory tag 107 in the printed media 109. By way of example, the user input may be indicated by tapping, touching or nearing the UE 101 towards the RF memory tag 107, i.e., tap UE 101 one or more times on, in the direction of or near the RF memory tag 107. The number of taps to initiate a request is configurable by the user, the service provider, or both. It is also contemplated that tapping includes bringing the UE 101 at least sufficiently close enough to the RF memory tag 107 so that the UE 101 can detect a return signal from the RF memory tag 107. A physical tap is not necessary. In addition or alternatively, the user can signal a request to select and read the RF memory tag 107 by activating one or more buttons or menu options on the UE 101, by otherwise causing the UE 101 to read the RF memory tag 107, or by any combination thereof.

After detecting the selection of the RF memory tag 107, the control module 201, for example, causes the RF memory tag reader/writer control module 203 to interact with an external RF memory tag reader/writer 205 (e.g., RFID reader/writer, NFC reader/writer, etc.). More specifically, the module 203, for instance, initiates the reader/writer 205 to download the promotional information contained in the RF memory tag 107. In certain embodiments, the RF memory tag reader/writer is a component of the UE 101 (e.g., a handset with a built-in reader) in which the tag-based content module 105 resides. In other embodiments, the reader/writer 205 may be an external peripheral attached to the UE 101.

Additionally, in cases where the RF memory tag 107 requires an access code, the control module 201 can provide the access code or request that the user enter the access code before initiating reading of the RF memory tag 107. In certain embodiments, the control module 203 presents one or more functions for enabling proof of presence of RF memory tags for automating the NFC detection process with respect to security and/or offer validation techniques. By way of example, proof of presence (e.g., mobile proof of presence) may be implemented via the tag based content module and services platform to enable check-in processing and quick response (QR) codes for location verification in addition to near field communication processing. Establishing proof of presence—i.e., that the user of a device was actually at the store location where a memory tag 107 is featured—ensures no duplication or copying of the tags can be generated in connection with virtual currency, coupons, free goods, etc. are offered.

In one embodiment, the services platform 111 can provide the access code to the control module 201 automatically. The RF memory tag reader/writer control module 203 stores the read promotional information in the tag information database 207. In one embodiment, the promotional information includes information to associate the promotional information with a specific section or portion of the object 109. The promotional information may also include an electronic or digital representation of the object 109B (e.g., an electronic version of a hardcopy magazine or catalog), one or more media files, one or more documents, one or more links to content, purchasing information, advertising information, an electronic catalog, or a combination thereof. If the RF memory tag 107 has write capabilities, the RF memory tag reader/writer control module 203 can direct the reader/writer 205 to write new information to the RF memory tag 107 including, e.g., updating the promotional information stored in the RF memory tag 109.

The control module 201 interfaces with a context recognition module 209 that receives image signal input from a camera 211 and a motion signal input from a movement/gesture module 213. In addition or alternatively, the movement may be detected by an accelerometer, radar technology, or another movement sensor. The context recognition module 209 processes the input to determine a context pattern, including a recurring location, activity, device function or mode, etc. The context information may be maintained for use by the offer/purchase management platform 115 as metadata for associating the object 109 with a RF memory tag read for a related item.

FIG. 2C is a diagram of the components of a services platform, according to an exemplary embodiment. In certain embodiments, the services platform 111 includes several components to support actions or content initiated by the tag-based content module 105 or performed by other components within the platform 111. It is contemplated that the functions of the components may be combined with the other elements of the system 100, and includes a services portal (e.g., store front) 221 for receiving service requests and delivering services to the UE 101. The services portal 221 has connectivity to a services catalog database 223 containing information to identify the services that are appropriate for performing the actions or delivering the content requested by the tag-based content module 105. On receipt of a request for service, the services portal 221 interacts with the database 223 and billing system (e.g., server) 225 to determine user information (e.g., user identity, user profile, etc.) and/or the billing information (e.g., monthly fee, discounts, promotions, product cost, credit card number, bank account, credit point) associated with the received service request. In one embodiment, the services portal 221 uses the billing information to generate a message requesting confirmation of the service management request from the user.

On receipt of the user confirmation, the services portal 221, for example, directs the payment gateway 227 to collect the fees associated with the request. In exemplary embodiments, the payment gateway 227 may interact with the network billing system 113 to collect payment using, for example: (1) direct billing to the user using the International Mobile Station Identity (IMSI) associated with the user's UE 101, wherein the user's phone bill is directly charged for any fees and the payment gateway 227 makes a billing request to the network billing system 113 to recover the fees based on the IMSI; (2) direct billing using a 3G/GPRS access point, wherein the user's phone bill is directly charged for any fees and the payment gateway 227 makes a billing request to the network billing system 113 to recover the fees based the network assigned ID (e.g., a Mobile Subscriber Integrated Digital Services Network (MSISDN) number); (3) direct billing using a wireless access protocol (WAP) access point 231, wherein the user's phone bill is directly charged for any fees and the payment gateway 227 makes a billing request to the network billing system 113 to recover the fees based the network assigned ID (e.g., MSISDN) (i.e., WAP direct billing); (4) direct billing using WAP 231, wherein the user accesses a WAP portal to authorize payment against the user's phone bill and the payment gateway 227 makes a billing request to the network billing system 113 to recover the fees (i.e., WAP online billing); (5) direct billing using premium short message service (SMS) MO billing wherein an SMS sent from the user's device triggers direct billing against the user's phone bill and wherein the network billing system 113 sends the collected fees to the payment gateway 227 based on the SMS transaction identification; (6) direct billing using premium short message service (SMS) MT billing wherein an SMS sent to the user's device triggers direct billing against the user's phone bill and wherein the network billing system 113 sends the collected fees to the payment gateway 227 based on the SMS transaction identification; (7) direct billing against a prepaid account associated with the one or more services; (8) direct billing to a user account registered with the services portal 221 (e.g., the Nokia Ovi Store) wherein the payment gateway 227 makes a billing request against the form of payment (e.g., credit card) registered with the services portal 221; and (9) direct billing against a third party payment provider (e.g., credit card payment provider).

In exemplary embodiments, the user, the service provider, or both can configure the payment mechanism used by the services platform 111. Operations of the services platform and/or may be performed in connection with a point-of-sales system or terminal for use in connection with a retail location (e.g., store, kiosk) of a merchant.

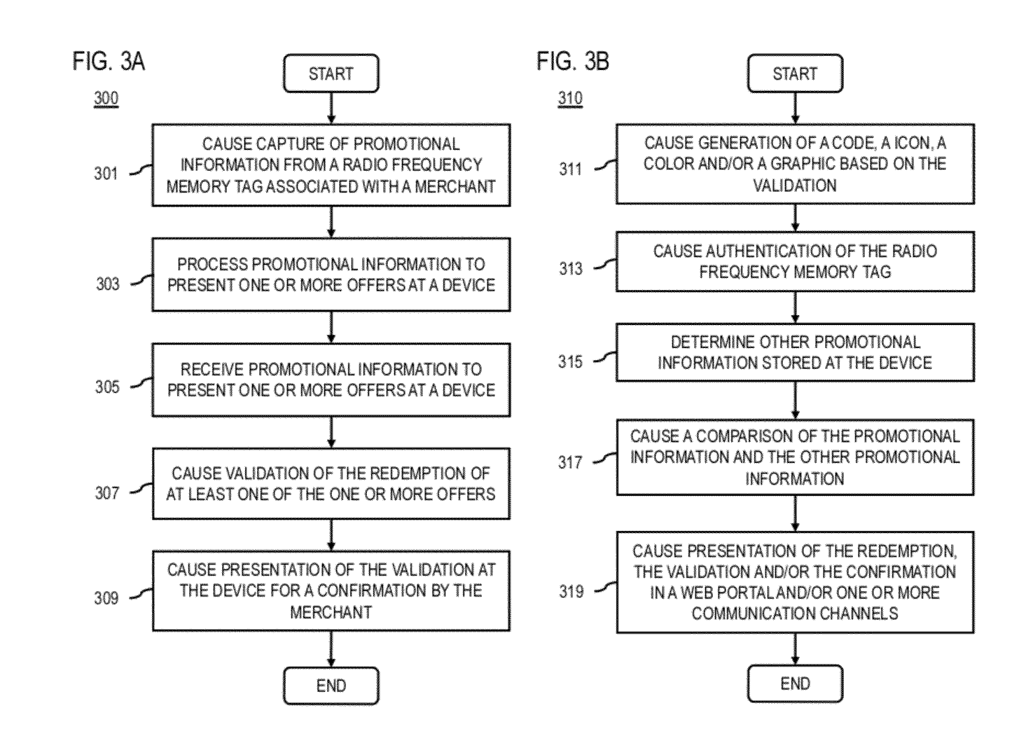

FIGS. 3A and 3B are flowcharts of a process for associating content information, such as that related to printed media, with a RF memory tag read for one or more items, according to various embodiments. For the purpose of illustration, the processes are described with respect to FIG. 1A. It is noted that the steps of the process may be performed in any suitable order, as well as combined or separated in any suitable manner. In step 301 of process 300 in FIG. 3A, a user device is enabled by the offer/purchase management platform 115 to capture promotional information from a radio frequency memory tag associated with a merchant. The radio frequency (RF) memory tag is unique to the merchant, one or more point-of-sales systems associated with the merchant, one or more clerks associated with the merchant, or a combination thereof. Also, as mentioned, the promotional information may include any data that is associated with or representative of an item available for purchase, acquisition, registration, etc. This includes a coupon, offer, incentive or other benefit associated with the item.

In step 303, the offer/purchase management platform 115 processes and/or facilitates a processing of the promotional information to present one or more offers at a device. In step 305, a network billing system and/or POS terminal operating in connection with the offer/purchase management platform 115 receives promotional information to present one or more offers at a device. By way of example, the one or more offers may include various coupons, rebates, etc available for use in connection with one or more items. Presentment of applicable offers is triggered by communication between the UE 101A that accessed a specific memory tag 107 and a POS tag 117A of the merchant.

Per step 307, the offer/purchase management platform 115 causes validation of the redemption of at least one of the one or more offers. The validation process may include execution of a validation user interface as provided by a merchant portal 117B. The merchant portal 117B may reveal the one or more coupons available to the user, applicable to the merchant or item, active for use, etc. In step 309, the offer/purchase management platform 115 causes presentation of the validation at the device for a confirmation by the merchant. The validation process may include entry of a verification code by the merchant or operator of the POS terminal, communication with another wireless communication device, etc.

In step 311 of process 310 (FIG. 3B), the offer/purchase management platform 115 causes generation of a code, icon, color and/or graphic based on the validation. The code, the icon, the color, the graphic, etc. is known by the merchant. As such, when the generated, the merchant may recognize the code, icon, color and/or graphic as a means of confirmation of the offer. Other means of confirmation/merchant validation may include the following as presented in Table 2:

TABLE 2
Displaying a 2D barcode on the display of the user equipment and
validating it with a separate merchant reader device. The reader device
can be, for example, smartphone with a merchant application that uses
the embedded camera to read the barcode or custom hardware.
The merchant can type in the displayed code to a web interface provided
by the merchant portal per a computing device linked to network
billing system 113/POS terminal.
The network billing system 113/POS terminal may include a web based
feed reader page that monitors the events of a specific POS tag to
see if a validation event is successful or not.
The merchant can use a NFC reader or low end device (having a separate
or a personalized smartphone application) to read (scan) the coupon
information from user's device.

In steps 313 and 315, the offer/purchase management platform 115 causes authentication of the radio frequency memory tag 107 and determines other promotional information stored at the device respectively. The other promotional information may include other coupons, offers and incentives associated with the user, the merchant, other offers or a combination thereof.

Per step 317, the offer/purchase management platform 115 causes a comparison of the promotional information and the other promotional information. This may include, as discussed, execution of a matching process between the promotional information on the device and other promotional information provided by the merchant in general. One or more offers are presented to the user or at the merchant portal based on the comparison.

In another step 319, the offer/purchase management platform 115 further causes presentation of the redemption, the validation and/or the confirmation in a merchant portal and/or the confirmation by way of one or more communication channels. The one or more communication channels may include the sending of a text message, multi-media message, e-mail, etc., to the user or the merchant. It is noted that the redemption process is based on the various authentication and conformation steps presented herein.

FIG. 4 is a diagram of a user interface utilized by a merchant for configuring one or more RF memory tags for use in connection with a promotion, according to one embodiment. By way of example, the interface corresponds to a tag configuration screen 400 as presented to a merchant via a merchant portal 117B, i.e., a cloud based service. To access the screen 400, the merchant performs a login process and is presented with various data fields for enabling the definition of memory tags, ordering of memory tags (i.e., from one or more affiliated providers), establishment of promotional information, establishment of related promotional information, or a combination thereof. It is noted that the merchant has the flexibility of reviewing certain predefined parameters of various tags as set by the one or more affiliates (e.g., providers) that distribute their goods and/or services via the merchant. In other instances, the merchant may be allowed to configure certain parameters regarding a promotion, such as to fit specific characteristics of their store, outlet, location, etc., while only being allowed to review certain other parameters preset by a given affiliate. The services platform 111 and/or offer/purchase management platform 115 periodically retrieves data regarding promotions (e.g., via the offer aggregation module 123) from the various affiliates and enables presentment via the merchant portal 117B.

For example, a quantity specification data field 409 and 407 may be used by the merchant for specifying a number of programmable RF memory tags 401 and/or advertisement banners 403 to be ordered, such as in connection with an advertisement campaign of a given affiliate. The merchant (e.g., a store manager) may select one or more “PROVIDER” identification action buttons 429-433 for selecting between the various items, including memory tags, posters, banners, flyers, placards and other promotional information made available by that particular affiliated provider. The merchant specifies a particular provider by selecting a button, which in turn causes presentment of the array of items pertaining to that provider—i.e., content is pushed down to the browser. In the case of an advertisement banner 403 or poster, it may include one or more embedded RF memory tags 401A. A tap count specification data field 405 and 411 may be featured for indicating a number of taps, nearings, touches, etc. required for activating the transfer or reading of promotional information as entered to one or more promotional information entry fields 413 and 415. In certain instances, the tap counts may be layered, wherein different numbers of taps correspond to the transfer or reading of different promotional information. By way of example, a total tap count may be established as 3, as shown with respect to the diagram; a second tap count may correspond to one promotional information message; and the first and third tap correspond to another 413. Under this scenario, the varying promotional information 413 and 415, including messages, instructions, offers, etc., may be defined respective to differing taps. In certain embodiments, the merchant may also modify the tap count setting based on permissions afforded by the provider.

The promotional information 413 and 415 for use with respect to an RF memory tag 401, advertisement banner or poster 403 may also be associated with or linked to additional resources, including a URL, URI or other data location reference or identifier. As such, tapping of the tag 401 or banner 403 results in execution of the browser application or web portal for retrieving content, including additional or other promotional information from the specified resource. As noted, NFC communication may also facilitate this process. The resource link entry field 421 and 423 may specify the link, i.e., for accessing place information. In addition to indicating a data location reference (e.g., URL), the merchant can browse for other documents and identifiers to be used for specifying the resource link by way of a “BROWSE” action button 417 and 419. Documents, hyperlinks, objects and other data may be retrieved from a local computing device from which the merchant portal 117B is enabled, a remote data source or a combination thereof.

Once the data is configured, the merchant is able to save the settings using by activating a “SAVE” action button 425 or cancel the settings by activating a “CANCEL” action button 427. In the case of the merchant being provided the promotional items by a given provider, they may select the “ORDER” action button 435 to facilitate the order fulfillment and delivery process. It is noted that various other features and data entry fields may also be provided for configuring and defining tags, promotional information, resource links, etc. For example, while not shown, the RF memory tags 401 may be associated with a specific identifier value on a per tag basis, associated with specific campaign, marketing or promotion code. As another example, one or more fields for enabling selection of a code, icon or other mark for merchant confirmation and validation may be chosen or established in connection with specific promotional information.

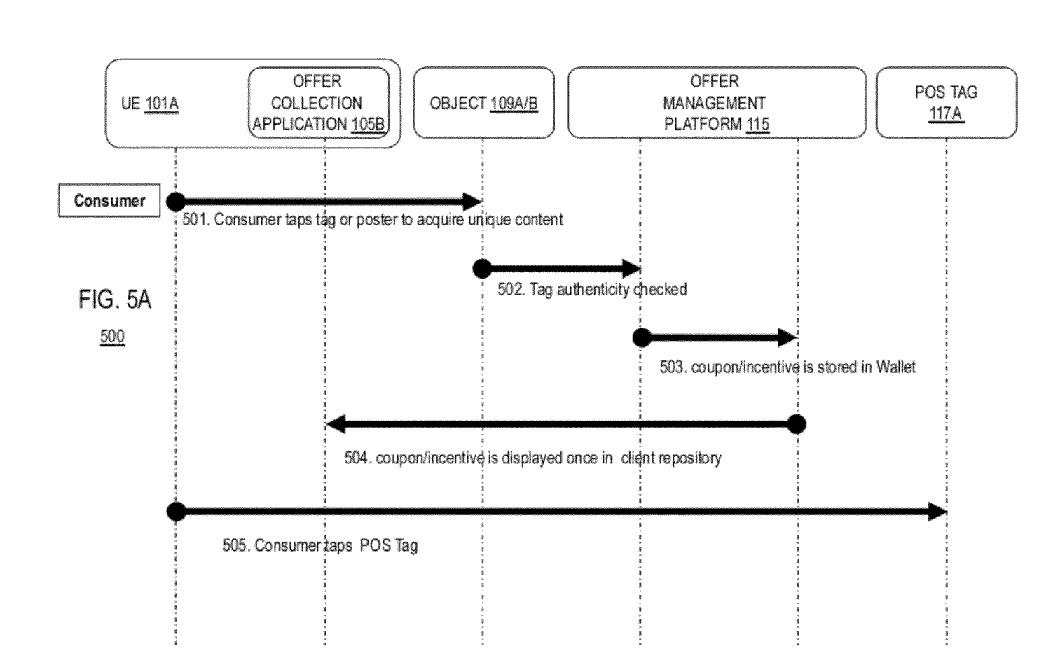

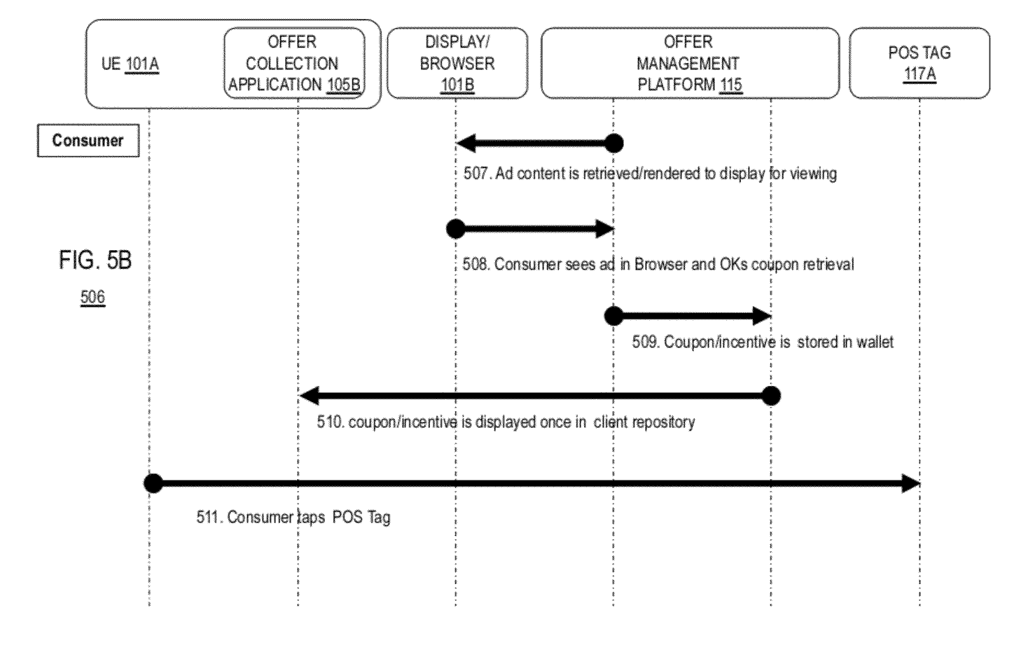

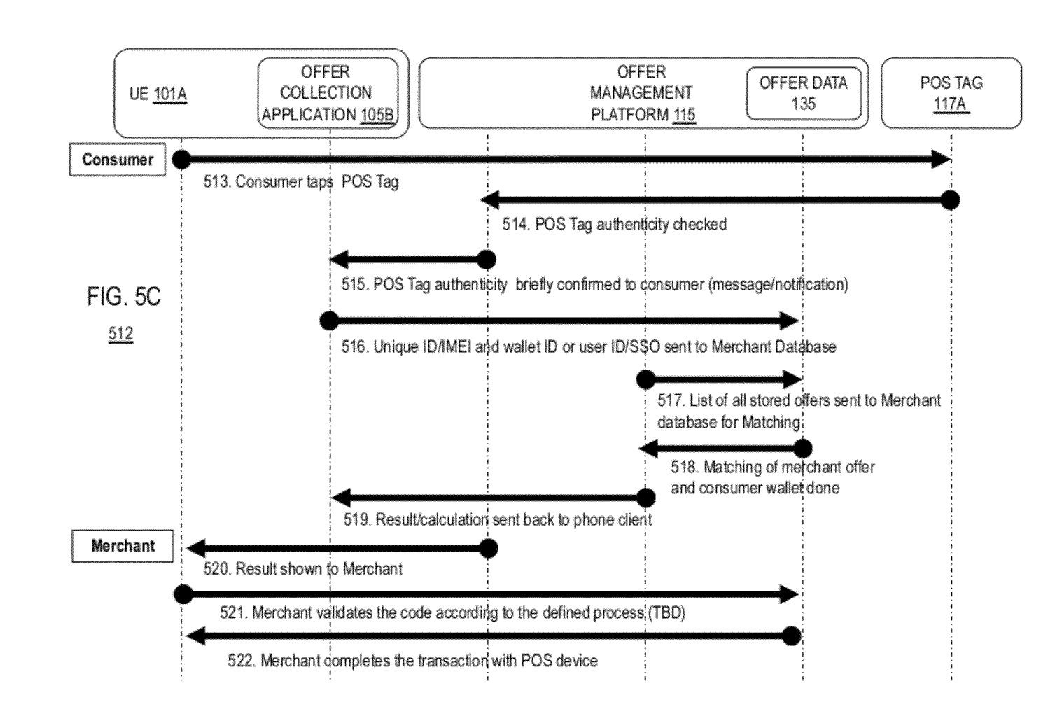

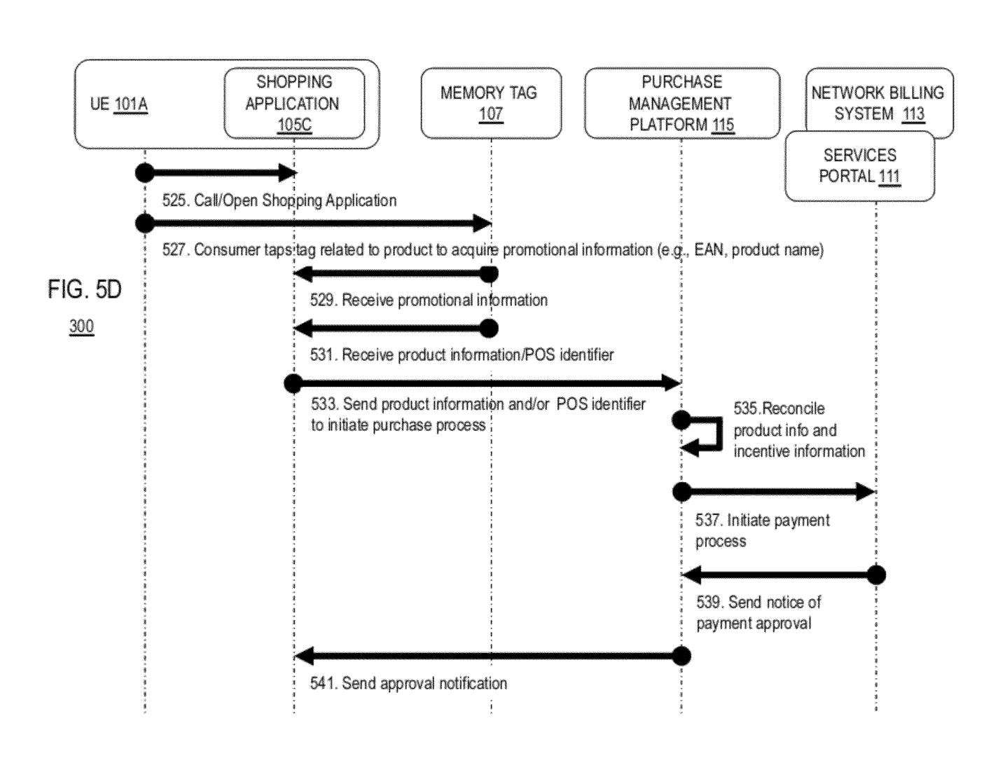

FIGS. 5A-5D are ladder diagrams depicting various stages of the process for facilitating processing of promotional information based on one or more RF memory tags read by a user device, according to various embodiments. FIG. 5A depicts the promotional information (content) acquisition process carried out with respect to an advertisement banner or poster. The steps 501-505 of the process 500 are presented from the perspective of consumer interaction with or in relation to the various elements of system 100 of FIG. 1A. In step 501, the consumer taps an RF memory tag at a poster (object 109A/B) with their user equipment 101A to acquire promotional information associated with the tag, including the downloading of coupons and other incentives. In steps 502 and 503, the offer/purchase management platform 115 validates the authenticity of the RF memory tag and/or associated coupon, and stores the coupon to a virtual wallet associated with the user. It is noted that the authenticity process performed by the offer/purchase management platform 115 may include a check to determine if a promotion is still active, expired, applicable based on the location of the user device (e.g., not applicable in Canada).

In another step 504, the coupon as placed into the virtual wallet (repository) is made available to the offer collection application 105B of the UE 101A. The offer collection application 105B is caused to enable display of the one or more coupons. Per step 505, the consumer is able to tap a POS memory tag 117A for enabling execution of a purchase transaction.

FIG. 5B depicts the promotional information (content) acquisition process carried out with respect to digital promotional information, such as that presented at a browser or web portal application via a user device. The steps 507-511 of the process 506 are presented from the perspective of consumer interaction with or in relation to the various elements of system 100 of FIG. 1A. In step 507, the offer/purchase management platform 115 provides advertisement content and/or promotional information to a display/browser 101B. It is noted that the display/browser 101B may be that of the UE 101A that is configured with the offer collection application 105B, or another computing device capable of accessing content via communication network 103. Upon receiving and reviewing the content, the consumer opts to retrieve/download the coupon per step 508, and the coupon is subsequently stored in the virtual wallet of the user, corresponding to step 509. In step 510, the coupon/incentive is them made available to the offer collection application 105B of the user device and made available for viewing by the user. Finally, as before, the consumer is able to tap a POS memory tag 117A for enabling execution of a purchase transaction, corresponding to step 511.

FIG. 5C depicts the promotional information (content) redemption process carried out with respect to coupons as stored in connection with a user, such as those already within a virtual wallet or maintained by the offer collection application 105B. The steps 513-522 of the process 512 are presented from the perspective of consumer interaction and/or merchant interaction with or in relation to the various elements of system 100 of FIG. 1A. In step 513, the device user taps the POS memory tag 117a to initiate the transactional process. Per step 514, the offer/purchase management platform 115 then checks the authenticity of the POS memory tag 117A and/or the promotional information associated with the tapping of the POS memory tag 117A. In response to an affirmation of the authenticity of the POS memory tag 117A and/or promotional information, a confirmation signal is presented to the offer collection application 105B, causing presentment of the message of confirmation accordingly to the display of the UE 101A. This corresponds to step 515.

Per step 516, the unique identifiers related to the transaction, including the user identifier, device identifier, promotional information identifier(s), merchant identifiers, etc., are sent to the merchant database (offer database 135) as maintained by the offer/purchase management platform 115. In addition, a list of all stored offers for the user is sent to the merchant for enabling cross-referencing/matching, corresponding to step 517. The offer/purchase management platform 115 then performs a matching process against the received identifier values for identifying all stored coupons/promotional information corresponding to the identifiers. As noted, this process entails ensuring alignment and applicability between a coupon and a promotion or advertising campaign. In steps 518 and 519 respectively, the matching process is performed and the result/calculation is presented to the user by way of the offer collection application 105B at the device. It is noted that the result is rendered to a display of the UE 101A accordingly to the user.

A merchant, such as an operator of a network billing system and/or POS terminal is presented with the result as well, per step 520. In step 521, the merchant validates the code according to one or more of the validation processes of Table 1. Once confirmed/validated, the merchant completes the transaction via the network billing system and/or POS terminal per step 522. Transaction completion may include successful execution of a purchase, registration, information gathering (e.g., transfer of a document, agreement, recipe, coupon book), subscription or other action pertaining to the promotional information indicated with respect to one or more RF memory tags.

FIG. 5D is a ladder diagram depicting various stages of the process for facilitating a purchase transaction based on one or more RF memory tags read by a user device, according to various embodiments. The steps 525-541 are presented from the perspective of consumer (device user) interaction with or in relation to the various components of system 100 of FIG. 1A. In step 525, the consumer uses their device (UE 101A) to call or open the shopping application 105C. Opening of the shopping application provides notification to the purchase management platform that the user is ready to shop with respect to a merchant to which the shopping application is associated. The notification message includes data for specifying at least the user identifier associated with the user, the merchant identifier associated with the merchant, or a combination thereof.

In step 527, the user taps an RF memory tag 107, which may be affixed to an object such as a poster for indicating an object 109A available for purchase. Alternatively, the RF memory tag 107 is directly affixed to the object 109A. The tapping, or other form of contact between a tag reading capable user equipment 101A and the tag, enables UE 101A to acquire promotional information associated with the tag. This may include, for example, the capture of coupons and other incentives, information regarding the product, consumer reviews, pricing details, etc. In steps 529 and 531, the shopping application 105C receives the promotional information as captured and/or product information and/or a POS identifier associated with the product (e.g., object) of interest. In certain embodiments, the product information is captured by way of an imaging device or audio recorder. Also, the POS identifier may be specified by the memory tag 107, entered manually, captured by way of imaging or audio techniques, etc.

Upon receipt, the shopping application 105C sends the product information and/or POS identifier to the purchase management platform 115 in order to initiate the purchase process. This corresponds to step 533 and occurs in response to a request by the user of the shopping application 105B to redeem the promotional information (e.g., coupon), purchase the product associated with the POS identifier and/or product information. Per step 535, the purchase management platform 115 then reconciles the product information/POS identifier. This may include reconciling or validating the data against profile data for a merchant, user or production information database to ensure proper association of the correct product, promotional information and merchant. Per the reconciliation process 535, the purchase management platform 115 is able to initiate the payment process (step 537), which accounts for any redeemed/applied promotional information (e.g., coupons) for affecting the final purchase price. The purchase management platform 115 performs processing of the payment by way of a network billing system 113 or services portal 111. Once approved (step 539), a notification of completion of the purchase transaction is sent to the shopping application 105b for user review (step 541). Per the executions of the virtual wall as it interacts in connection with the shopping application 105B, the notification of completion may be stored as a transactional receipt or record for quick recall at a later time.

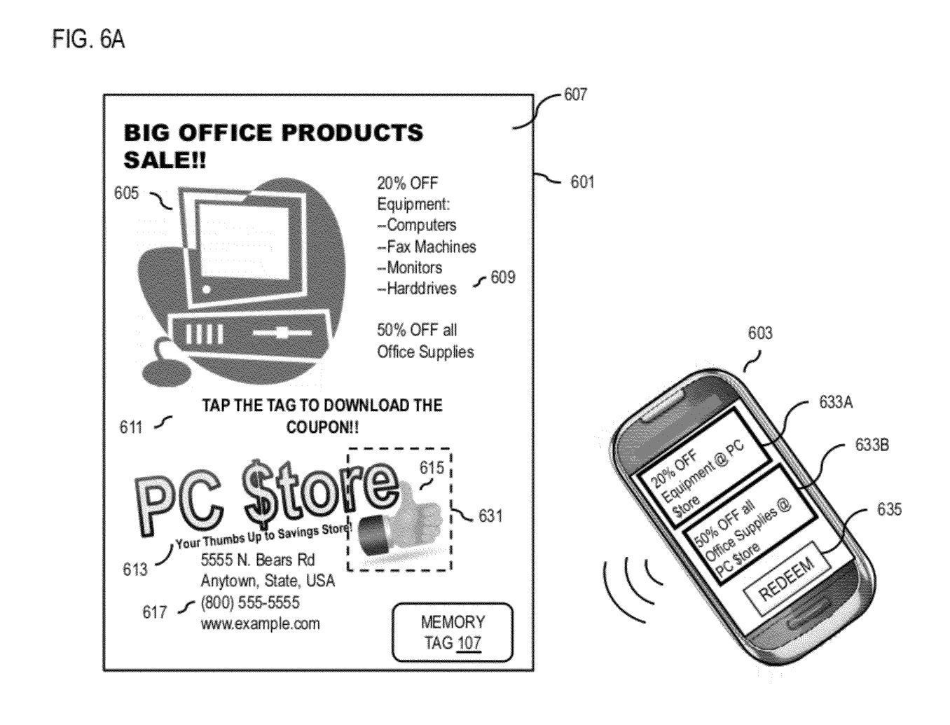

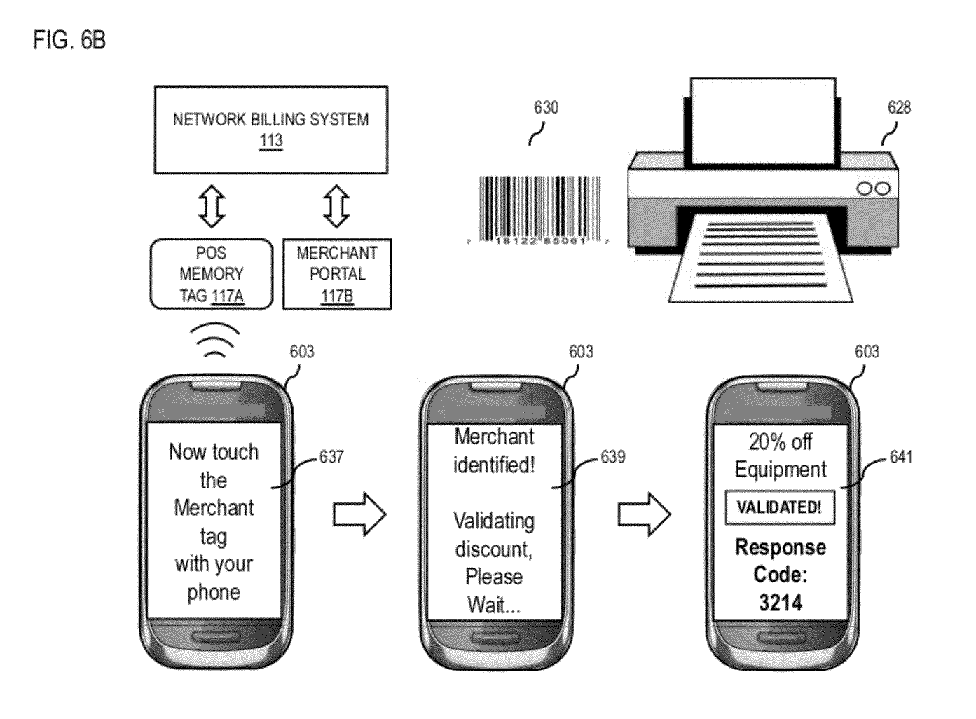

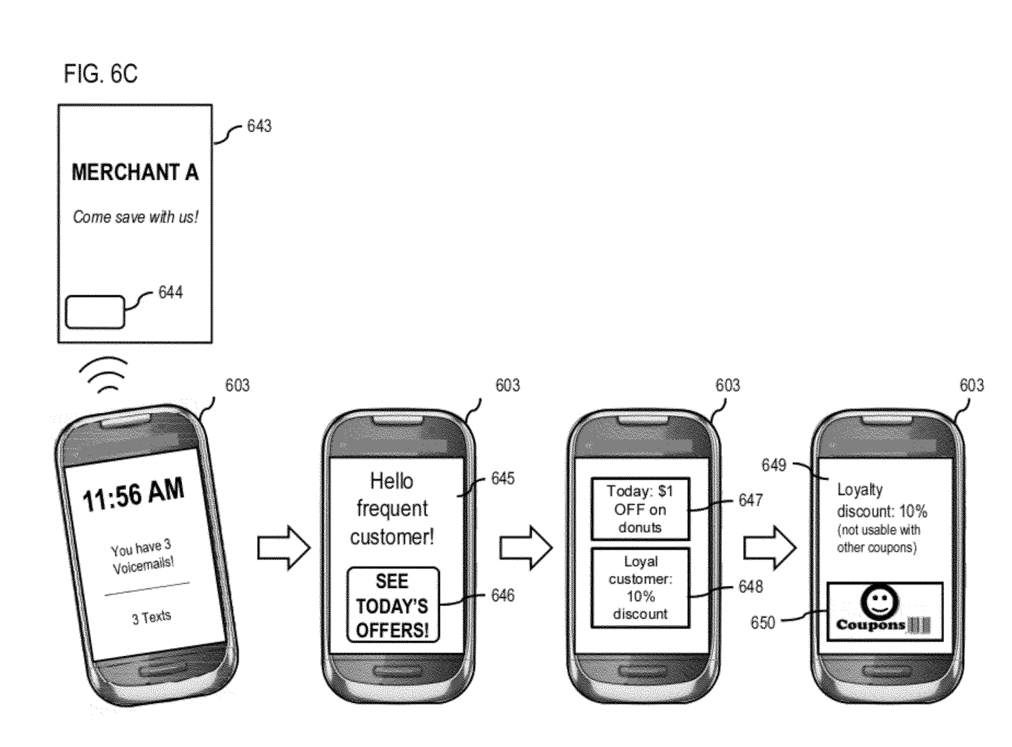

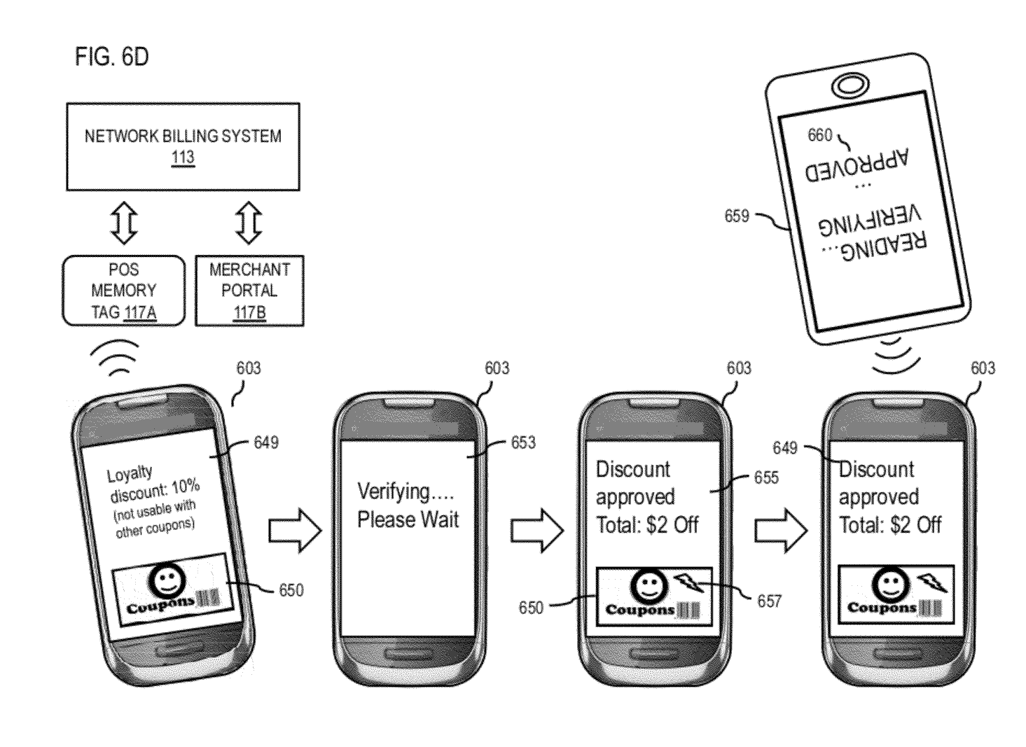

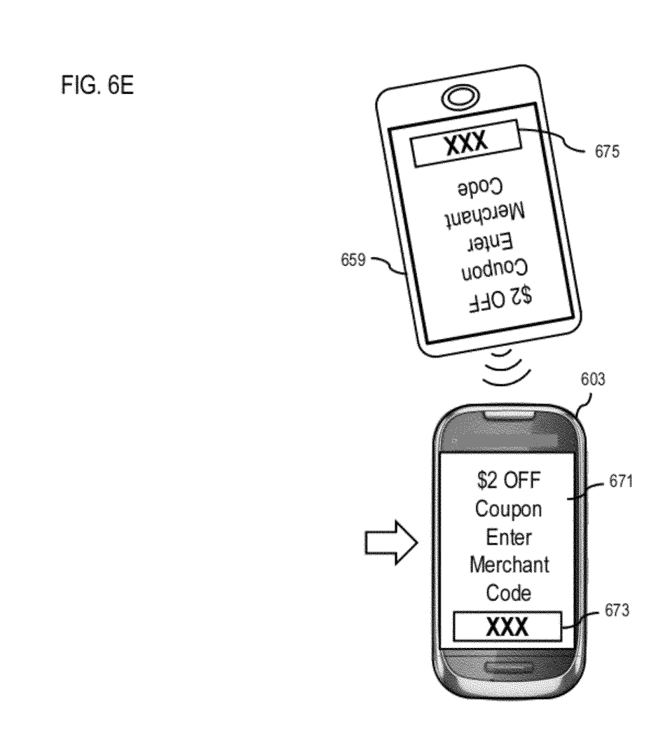

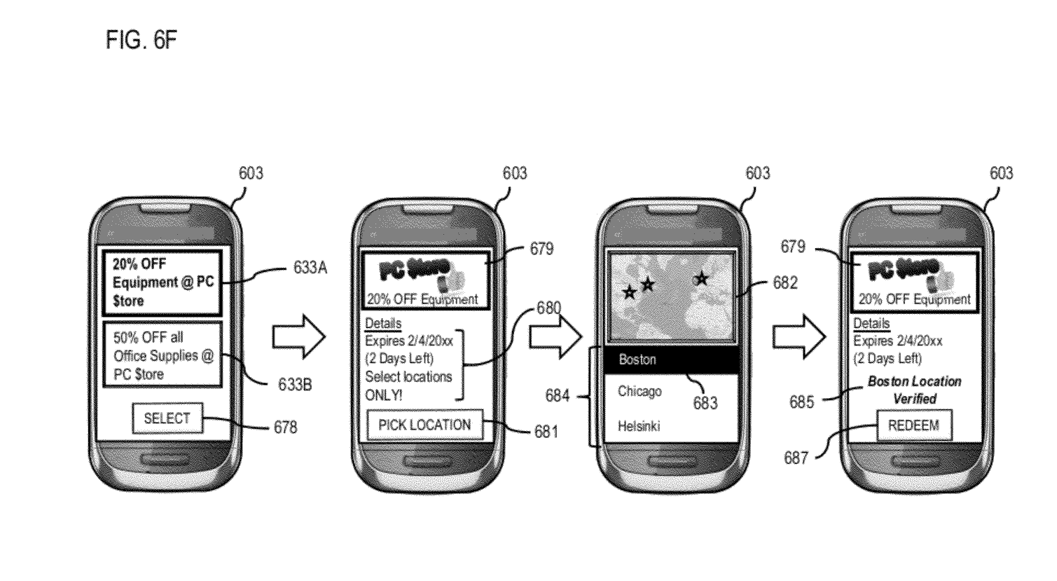

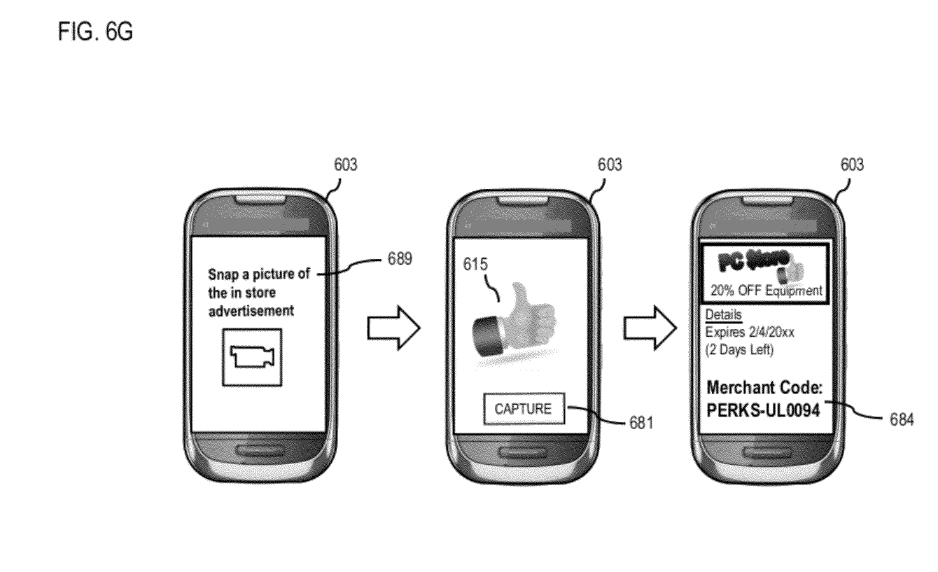

FIGS. 6A-6G are diagrams of user interfaces utilized in the processes of FIGS. 3A and 3B, according to various embodiments. It is also noted the user interfaces correspond to various steps presented with respect to the ladder diagrams of FIGS. 5A-5C. For the purpose of illustration, the diagrams are described with respect to an exemplary use case of a mobile device user that observes and captures data pertaining to printed media 401 (e.g., an advertisement) created by a fictitious office products and equipment supplier (PC $tore). While presented herein as an advertisement, it is noted that printed media may include any item for displaying print (e.g., leaflets, brochures, stickers) and may also be employed for purposes other than retail.

In FIG. 6A, the printed media 601 includes various content, including: a graphic 605, an announcement 607, information 609 regarding one or more items (e.g., products) available for purchase, promotional offer instructions/details 611, a retailer brand name 613 and logo 615 and contact information 617 pertaining to the retailer. The advertisement announces a sales event relating to the one or more items, which in this case is office supplies and office equipment. A RF memory tag 107 is also affixed to the printed media 601 for enabling user interaction with the print media (e.g., accessing of additional information via a web link or direct downloading of promotional information such as coupons).

The user's mobile device 603 is configured in the manner discussed with respect to user device 101A of FIG. 1A. As such, the user is able to read and/or capture content information as conveyed with respect to the printed media 601 by way of a tag reader or alternatively, by way of a camera of the device. The various embodiments presented herein contemplate operation of the mobile device 603 for capturing any content information, including that based on RF memory tags 107, symbols or other indicators representative of a given retailer, brand, item, etc. By way of example, the device 603 may capture a portion 631 of the printed media 601 featuring the company logo 615.

Under this scenario, the user the user has the offer collection application 105B running on the mobile device. Once the user taps the memory tag 107, the selected coupon is displayed on the display of the device 603. In this example, two promotional offers are associated with the RF memory tag 107, including an offer/coupon for “20% off all equipment” 633A and “50% OFF all office supplies” 633B via the merchant PC $tore. Also presented to the screen is a “REDEEM” action button 635 for enabling the user to redeem any one of the selected coupons 633A or 633B.

It is noted that the above described scenario entails a process of staging the user device 603 with one or more offers in advance of the purchase transaction process. However, as discussed previously, the user can optionally skip this phase altogether and have the best coupon/incentive/offer matched with the user automatically by tapping the merchant POS memory tag, such as prior to checkout.

Once the user selects the “REDEEM” action button 635, the user's coupon application enters NFC tag reading mode and waits for the user to tap a compatible tag at the merchant POS terminal, as shown in FIG. 6B. By way of example, the user device 603 presents a message 637 indicating that the user is to touch the merchant tag. The user then identifies a printer device 628 they want to purchase based on the discount and proceeds to the checkout line or other location of the merchant POS terminal. The box for housing the printer device 628 also includes barcode data 630 for enabling quick scanning of the device at the POS terminal.

Once the user taps, nears, touches or otherwise communicates with the merchant POS memory tag 117A (e.g., via NFC communication), the offer collection application on the user's mobile device 603 receives the merchant information from the POS memory tag 117A and consequently connects to the offer/purchase management platform 115 to check the coupon validity. As mentioned previously, the validation process may be based, at least in part, on the merchant tag identifier and selected coupon information or identifiers. A message 639 is generated to the display of the user device 603 for indicating whether the merchant is recognized and the status of the validation process with respect to the coupon.

It is noted that the connection between the user device and the offer/purchase management platform 115 can be performed over a communication network 103 in accord with any available communication protocol, i.e., hypertext transfer protocol (HTTP) or simple messaging service (SMS). It is also noted that if no coupon was selected for redemption prior to tapping of the POS memory tag 117A, the offer/purchase management platform 115 is configured to match the best available offer combination from the user's wallet. In certain embodiments, it is also contemplated that the barcode featured on the packaging of the device (e.g., printer 628) can be used to initiate recalling of the best offers. By way of example, upon tagging of the POS memory tag 117A, the device identifier value, user identifier, merchant identifier, context information and other data for identifying the user, product, merchant, etc. can be associated with the barcode for retrieving applicable promotional information 135 according to the device user's profile. Under this scenario, the barcode information may also be used as a reference for identifying and retrieving coupons from the user's virtual wallet on demand.

Once the validation process is deemed successful, a message 641 indicating the coupon is validated along with a response code is displayed on the mobile device screen. When deemed unsuccessful, a message indicating the coupon is invalid along with an explanation and/or error response code is presented.

FIG. 6C depicts a scenario wherein the user of device 603 encounters a merchant advertisement to initiate a coupon presentment process at their device, i.e., by way of the offer collection application 105B initiating the display of digital promotional information at the display/browser. This corresponds to an instance wherein the user did not recall any coupons from their virtual wallet in advance or initiate redemption of coupons per the offer collection application 105B. By way of example, the user taps the advertisement 643 upon walking into the merchant store location. The advertisement 643 features an RF memory tag 644 having stored thereon promotional information. Responsive to reading of the RF memory tag 644, personalized information pertaining to the user is presented to the device 603. In this example, a personalized message 645 for indicating the user is a recognized frequent shopper is presented along with a action button 646 for retrieving a list of available offers (i.e., for facilitating proof of presence checkin) The personalized information can be triggered by detection of a user identifier and/or device identifier via the offer/purchase management platform 115. Also, place information—i.e., a link to a specific location of promotional information online—can be personalized for the user based on known social network information, frequency of visits to the merchant location, prior buying habits, typical location of purchase, etc.

Upon selecting the action button 646 for viewing available offers, the user is presented with one or more options/offers 647 and 648. A first offer 647 corresponds to $1 OFF on donuts while the second 648 is a loyal customer discount of 10%. The user can select several offers to take advantage of or one at a time. Under this scenario, the user selects the loyal customer discount, thus prompting presentment of a message 649 for displaying details about the coupon. In addition, the message 649 displays the coupon 650 corresponding to the user device by way of the offer collection application 105B operating in connection with the offer/purchase management platform 115. Of note, incompatible discounts and campaigns are not allowed to be presented. The user is now ready to activate the coupon 650 at the merchant network billing system 113/POS terminal.

In FIG. 6D, the user goes to the POS terminal to redeem the selected coupons and taps the POS memory tag 117A. The POS memory tag 117A directs a user interface enabled by a merchant portal 117B to a merchant redemption page and triggers opening of the user's coupon repository/wallet. As mentioned, the repository/virtual wallet presented via the merchant portal correspond to that viewable by the user via the offer collection application 105B of the device 603. The offer/purchase management platform 115 then matches the coupons in the user's coupon virtual wallet/repository against the coupon to which the user is attempting to redeem. A message 653 for indicating the status of the matching/verification process is presented to the device display.

Once the discount is approved, a message 655 indicating approval is presented to the display of the device 603. By way of example, the message 655 indicates a final recommended discount as a result of the match along with a code, symbol or other indicator 657 for indicating to the merchant (e.g., POS operator) that the discount is valid. In certain embodiments, the indicator 657 may also be presented to the device in the form of a color change, orientation change, size change of the coupon, flashing or blinking, sound, or other display transformation or device alert means.

Per the various validation/confirmation options of Table 1, the user may also execute further confirmation steps. For example, the merchant can verify coupon redemption with a web application that monitors the activity of a specific POS tag. While not shown, this redemption process may be carried out by way of the merchant portal 117B. In another example, the confirmation process may be facilitated by way of a verification application operable in connection with the merchant's mobile device 659. Under this scenario, the merchant's mobile device 659 is also enabled for NFC, and thus reads the coupon information at the user device 603 in order to return a verification result (e.g., “APPROVED” 660). FIG. 6E presents another merchant confirmation/validation process wherein the merchant enters a confirmation code at the users device 603 or at their NFC enabled device 659. In the former scenario, the user device 603 is caused to present a verification message 671, which includes a field 673 for enabling entry of a verification code.

The user hands the phone 603 to the merchant, and the merchant has the option of entering the validation code into a data entry field 673 or not. Once entered, the discount is issued and recorded by the POS terminal for accounting purposes and the purchase transaction according to the discount is commenced. Alternatively, the verification code may be entered into a code entry field 675 of the merchant's NFC enabled mobile device 659.

It contemplated, in certain embodiments, that near-field communication (NFC) between the user device 603 of a purchaser and the merchant (e.g., operator of a point-of-sales terminal) device 659 is engaged for enabling non-physical tag events. Hence, the procedure for enabling the recalling of promotional information is not triggered by tagging, tapping, touching, or any means of physical contact of the user device 603 with respect to a POS memory tag 117A of the merchant. By way of example, the user device 603 may access place information upon detecting the presence of the POS memory tag—i.e., due to establishment of a NFC event between the user device and a device of the merchant 659. In this scenario, both devices are configured accordingly for establishing a proximity based communication session and interfacing with the offer/purchase management platform and/or network billing system 113. Once established, the user device 603 is caused to present (e.g., via a browser application) place information corresponding to the merchant. Content available as place information may include various promotions, advertisement, coupons, incentives or other information. It is noted that presentment may be contingent upon validation of proof-of-presence information as facilitated based, at least in part, on the NFC event.

It is noted that this approach to enabling the processing of promotional information (e.g., coupons) by-passes the need for memory tag generation and production by the merchant via the tag configuration procedure as described by way of example in FIG. 4. Resultantly, the merchant may be able to achieve faster time-to-market distribution of goods and services with respect to the promotion in question given that no programming or defining of tag behavior need be performed. The only requirement is the hosting of digital promotion information 109B as a channel for distributing data to the consumer and merchant (e.g., including a compatible widget or application for promotion or purchase processing) via their respective devices. Alternatively, the widget may be pre-loaded on respective devices and activated through a registration means.

FIG. 6F presents a verification process wherein location information regarding the user device 603 is validated in order to enable access to promotional information. By way of example, GPS information matching the location of valid use of a coupon is required to establish proof of presence and enable POS processing.

As described previously, the user may view the various coupons 633A and 633B they have accumulated, such as by way of a virtual wallet viewer or application. The user then selects a particular coupon of interest by activating a “SELECT” action button 678. For example purposes, when the user selects coupon 633A corresponding to the offer from PC $tore, the display is caused to present details 680 regarding the offer. The details may include descriptive text representative of a date of offer expiry, the number of days left for use of the coupon, a digital depiction of the coupon 679, etc. Also included within the detail description 680 is an indication that the offer is only valid at select locations. The user may select a “PICK LOCATION” action button 681 to initiate viewing of the select locations wherein the coupon is valid.

In response to selecting the action button 681, the display presents a listing of locations 684 corresponding to the coupon. A map 682 is presented to show the various store locations against geographic data along with a listing 684 of the available locations available for selection. When the user selects a particular option, i.e., Boston 683, this action triggers activation of a location service (e.g., GPS service) for verifying the location and/or position of the user device 603. It is noted the determination may be employed as a means of proof of presence verification respective to the device. When a match is found between the present location of the device 603 and the store location, the device display is updated to present a message 685 for indicating the location is verified. The user may then redeem the coupon 679 by selecting a “REDEEM” action button 687.

In FIG. 6G, as further proof of presence and coupon redemption processing, the user is presented with a message 689 requiring they snap a picture of the advertisement corresponding to the item of interest. The message 689 may also include a warning indicating the image must be captured in order to further enable validation of the coupon. By way of example, the user captures an image 631 of the logo 615 corresponding to the in store advertisement for PC $tore as shown in FIG. 6A. The user may be required to capture an image of the entire poster, a code featured on the poster, etc. It is noted in certain embodiments that the user may also be required to read the RF memory tag 107 affixed to the poster 601 as part of the verification/redemption process.

The capture process is facilitated by selecting a “CAPTURE” action button 681, which in turn triggers an image verification process. Having captured the picture and location information of the user, proof of presence is established and a merchant code 684 is presented along with the coupon information for presentment to the merchant. While the processing of the location information and image information are shown herein as separate processes, they may be performed concurrently as a means of executing proof of presence.

The above mentioned merchant verification options may be invoked in accordance with individual merchant policies and/or user preferences specified by profile information maintained for the user. Hence, different marketing and/or advertising campaigns may be linked to different confirmation/verification executions based on the preferences of the user, merchant or a combination thereof. By way of example, when it is determined the user of a device attempting to redeem a coupon is an unfavorable shopper or a customer that has yet to pay an outstanding balance, the verification process requiring merchant validation code entry may be activated for enabling the merchant to refrain from coupon redemption (e.g., pending payment of the balance). As another example, the verification process may be invoked in connection with a credit card solicitation campaign wherein the verification code is entered by the merchant only upon successful completion of a credit card application or other stipulation.

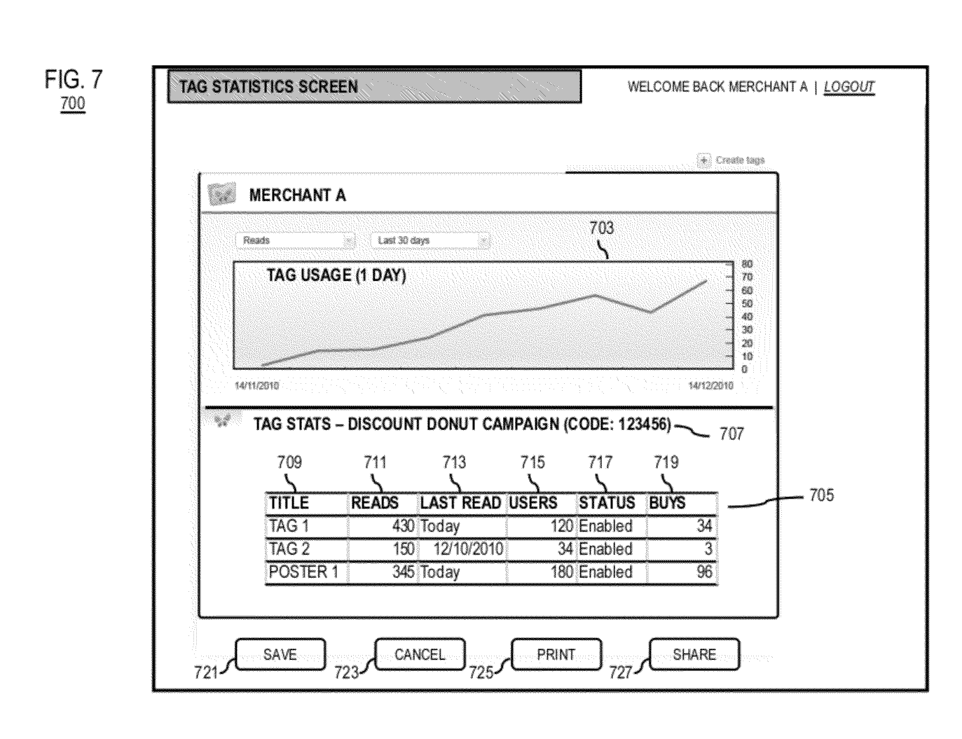

FIG. 7 is a diagram of a user interface utilized by a merchant for reviewing report data pertaining to one or more RF memory tags for use in connection with a promotion, according to one embodiment. By way of example, the tag statistics screen 700 is presented by way of the merchant portal 117B. The tag statistics screen presents various data, including graphs 703 and tables/cells (of a spreadsheet 705) for indicating various tag usage statistics. Compilation of this data may be used to generate a report for indicating the effectiveness of a marketing campaign employing the use of one or more tags, for refining a banner or advertisement location, for developing customized individual user marketing schemes, etc.

By way of example, the spreadsheet 705 of the tag statistics screen 700 presents the various columns of data, including a title and/or name column 709 of a tag or poster used in connection with a promotion, a reads column 711 for indicating a number of times a tag or poster was accessed, a last read column 713 for indicating the last time a tag or post was read by a NFC enabled user device, a users column 715 for indicating the number of individual users that accessed the tag or poster, a status column 717 for indicating whether the tag or poster was active/enabled and a buys column 719 for indicating the number of purchase transactions associated with a given tag or poster. Under this scenario, RF memory tags TAG 1 and TAG 2 were used along with POSTER 1 in connection with a campaign corresponding to promotion code 123456 (e.g., code 707). The merchant may access the merchant portal 117B to view such data and analyze results. For instance, it is shown that while TAG 1 received the most reads 711, it resulted in fewer buys 719 than POSTER 1, which received fewer reads 711 but more users 715. This information may be used to assess the effectiveness of the respective resources.

Upon generating and viewing the reports and statistics, the merchant can save customer generated reports by selecting a “SAVE” action button 721, cancel reports by selecting a “CANCEL” action button 723, print reports by selecting a “PRINT” action button 725 and share reports by selecting a “SHARE” action button 727.

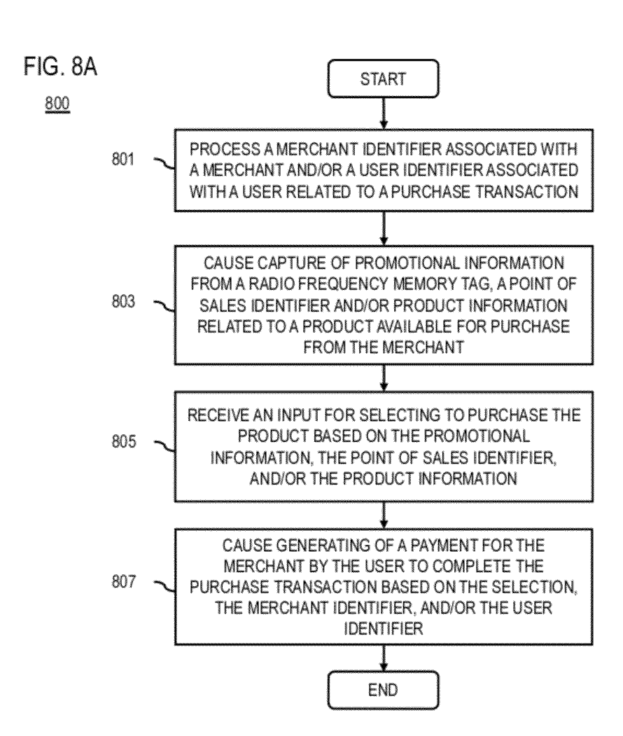

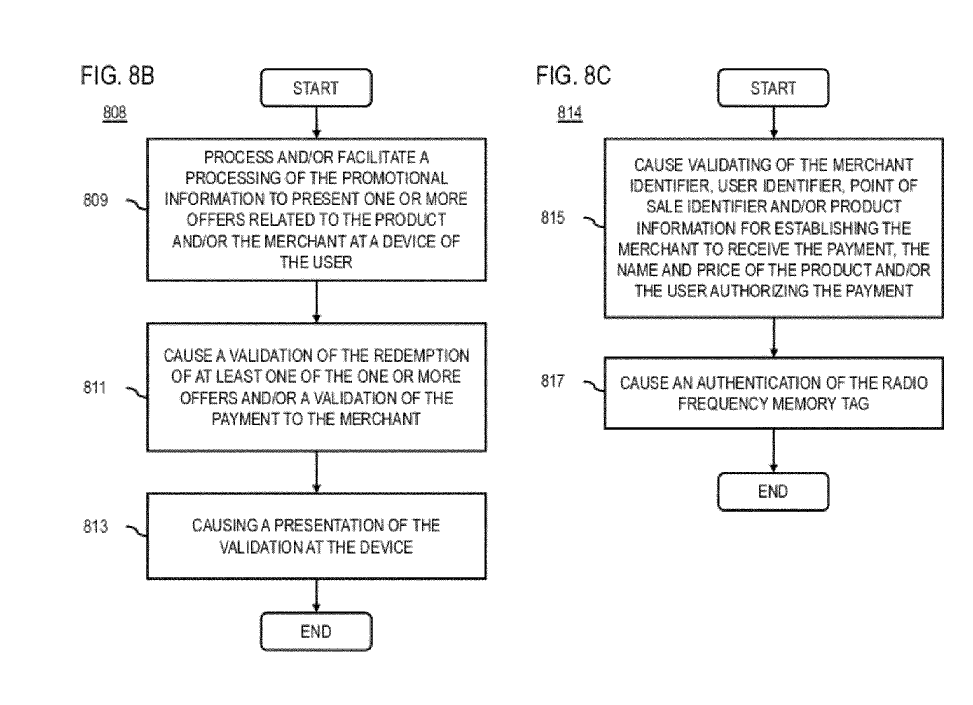

FIGS. 8A-8C are flowcharts of a process for facilitating a purchase transaction based on one or more RF memory tags read by a user device, according to various embodiments. For the purpose of illustration, the processes are described with respect to FIG. 1A. It is noted that the steps of the process may be performed in any suitable order, as well as combined or separated in any suitable manner. In step 801 of process 800 in FIG. 8A, a user device is enabled by the offer/purchase management platform 115 to process a merchant identifier associated with a merchant, a user identifier associated with a user, or a combination thereof related to a purchase transaction. In another step 803, the management platform 115 causes capture of promotional information from a radio frequency memory tag, a point of sales identifier, product information, or a combination thereof related to a product available for purchase from the merchant. As noted previously, a user device may be equipped with a tag reader and other associated technology for enabling the capture of this information.

In step 805, the purchase management platform receives an input for selecting to purchase the product based, at least in part, on the promotional information, the point of sales identifier, the product information, or a combination thereof. As noted, the input may be received as image data of the object of purchase itself, a point of sale identifier, or a combination thereof. Other forms of input may include audio, textual data or signal data associated with reading of the RF memory tag. Per step 807, the purchase management platform 115 causes generating of a payment for the merchant by the user to complete the purchase transaction based on the selection, the merchant identifier and/or the user identifier. This may include initiating communication with a payment services provider to facilitate the directing of payment to the merchant.

In step 809 of process 808 (FIG. 8B), the purchase management platform 115 processes promotional information to present one or more offers related to the product, the merchant, or a combination thereof at the device of the user. In another step 811, the platform 115 causes a validation of the redemption of at least one of the one or more offers and/or a validation of the payment to the merchant. Per step 813, a presentation of the validation is caused at the device. This may include, for example, presentment of a notification message to the display of the device for indicating the validation. Alternatively, the presentment may include the sounding of an alarm or alert for indicating validation of the purchase transaction.

In step 815 of process 814 (FIG. 8C), the platform 115 causes validation of the merchant identifier, user identifier, point of sale identifier and/or production information for establishing the merchant to receive the payment, the name and price of the product and/or the user authorizing the payment. In another step 817, the platform 115 causes an authentication of the radio frequency memory tag. The redemption, the purchase, or a combination thereof, are based on the authentication. Steps 815 and 817 correspond to the authentication and verification steps for enabling proof of purchase transactions without any additional merchant or vendor equipment.

The exemplary techniques and system presented herein enables device users to persistently aggregate promotional information that can be redeemed on demand at a merchant POS terminal. In addition, the user is able to maintain and query a virtual wallet containing one or more accumulated offers for matchup against any available promotions offered by a merchant in response to the reading of location independent RF memory tag.

The processes described herein for processing coupons/purchases based on memory tag detection may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

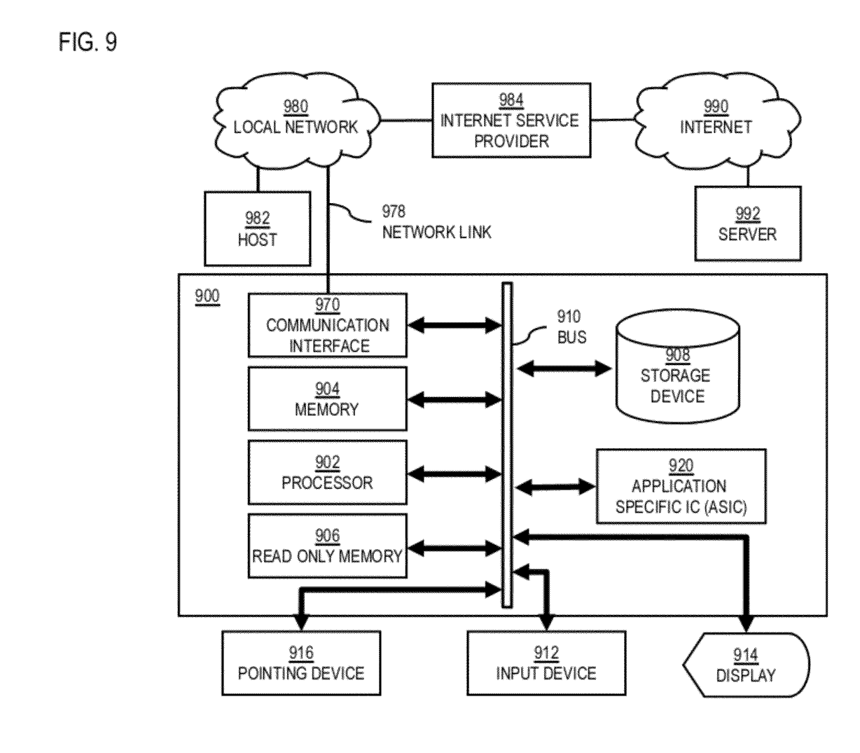

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to process coupons/purchases based on memory tag detection as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of processing coupons/purchases based on memory tag detection.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to processing coupons/purchases based on memory tag detection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for processing coupons/purchases based on memory tag detection. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for processing coupons/purchases based on memory tag detection, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for processing coupons/purchases based on memory tag detection.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

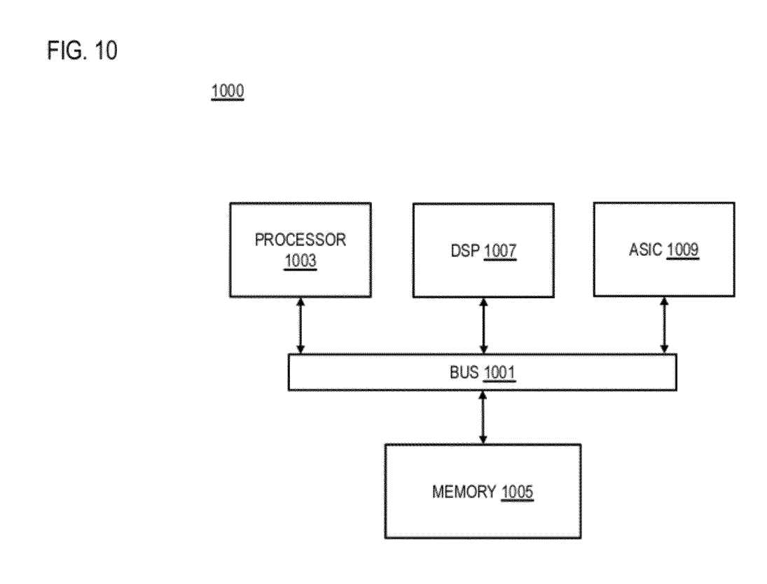

FIG. 10 illustrates a chip set or chip 1000 upon which an embodiment of the invention may be implemented. Chip set 1000 is programmed to process coupons/purchases based on memory tag detection as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of processing coupons/purchases based on memory tag detection.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to process coupons/purchases based on memory tag detection. The memory 1005 also stores the data associated with or generated by the execution of the inventive steps.

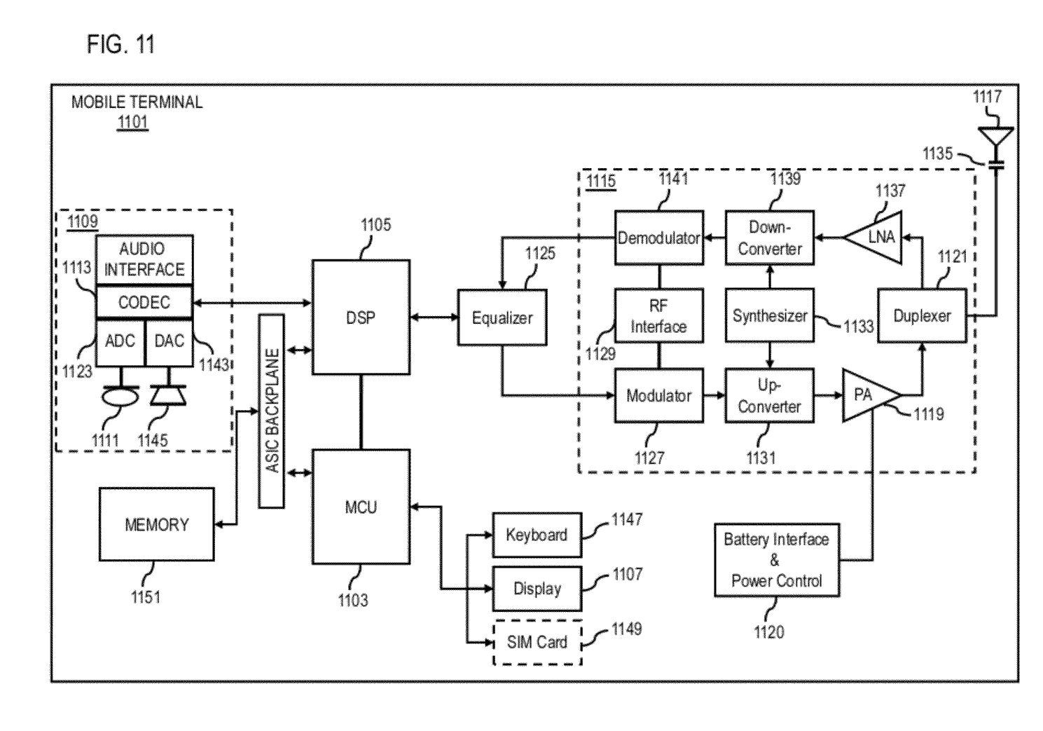

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of processing coupons/purchases based on memory tag detection. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of processing coupons/purchases based on memory tag detection. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to process coupons/purchases based on memory tag detection. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a capture of promotional information from a radio frequency memory tag associated with a merchant;
a processing of the promotional information to present one or more offers at a device;
an input for selecting at least one of the one or more offers for redemption;
a validation of the redemption of at least one of the one or more offers; and
a presentation of the validation at the device for a confirmation by the merchant.

2. A method of claim 1, wherein the (1) data and/or (2) information and/or (3) at least one signal are further based, at least in part, on the following:
a generation of location information, a code, an icon, a color, a graphic, or a combination thereof based, at least in part, on the validation,
wherein the presentation of the validation includes, at least in part, the location information, code, the icon, the color, the graphic, or a combination thereof known to the merchant.

3. A method of claim 2, wherein the confirmation by the merchant is based, at least in part, on confirming the code, the icon, the color, the graphic, or a combination thereof with a service.

4. A method of claim 1, wherein the (1) data and/or (2) information and/or (3) at least one signal are further based, at least in part, on the following:
an authentication of the radio frequency memory tag,
wherein the redemption is based, at least in part, on the authentication.

5. A method of claim 1, wherein the (1) data and/or (2) information and/or (3) at least one signal are further based, at least in part, on the following:
other promotional information stored at the device; and
a comparison of the promotional information and the other promotional information,
wherein the one or more offers are presented based, at least in part, on the comparison.

6. A method of claim 5, wherein the other promotional information includes, at least in part, information read from one or more other radio frequency memory tags associated with the merchant, from one or more web pages associated with the merchant, from one or more communications associated with the merchant, or a combination thereof.

7. A method of claim 1, wherein the (1) data and/or (2) information and/or (3) at least one signal are further based, at least in part, on the following:
causing, at least in part, generation of at least one report of the redemption, the validation, the confirmation, or a combination thereof.

8. A method of claim 1, wherein the radio frequency memory tag is unique to the merchant, one or more point-of-sales systems associated with the merchant, one or more clerks associated with the merchant, or a combination thereof.

9. A method of claim 1, wherein the (1) data and/or (2) information and/or (3) at least one signal are further based, at least in part, on the following:
a capture of promotional information, a point of sales identifier, product information, or a combination thereof related to a product available for purchase from the merchant; and
an input for selecting to purchase the product based, at least in part, on the promotional information, the one or more offers, the point of sales identifier, the product information, or a combination thereof.

10. A method of claim 9, wherein the (1) data and/or (2) information and/or (3) at least one signal are further based, at least in part, on the following:
a generation of a payment for purchasing the product based, at least in part, on the selection to purchase, the merchant information, user information, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a capture of promotional information from a radio frequency memory tag associated with a merchant;
process and/or facilitate a processing of the promotional information to present one or more offers at a device;
receive an input for selecting at least one of the one or more offers for redemption;
cause, at least in part, a validation of the redemption of at least one of the one or more offers; and
cause, at least in part, a presentation of the validation at the device for a confirmation by the merchant.

12. An apparatus of claim 11, wherein the apparatus is further caused to:
cause, at least in part, a generation of a code, an icon, a color, a graphic, or a combination thereof based, at least in part, on the validation,
wherein the presentation of the validation includes, at least in part, the code, the icon, the color, the graphic, or a combination thereof known to the merchant.

13. An apparatus of claim 12, wherein the confirmation by the merchant is based, at least in part, on confirming the code, the icon, the color, the graphic, or a combination thereof with an service.

14. An apparatus of claim 1, wherein the apparatus is further caused to:
cause, at least in part, an authentication of the radio frequency memory tag,
wherein the redemption is based, at least in part, on the authentication.

15. An apparatus of claim 11, wherein the apparatus is further caused to:
determine other promotional information stored at the device; and
cause, at least in part, a comparison of the promotional information and the other promotional information,
wherein the one or more offers are presented based, at least in part, on the comparison.

16. An apparatus of claim 15, wherein the other promotional information includes, at least in part, information read from one or more other radio frequency memory tags associated with the merchant, from one or more web pages associated with the merchant, from one or more communications associated with the merchant, or a combination thereof.

17. An apparatus of claim 11, wherein the apparatus is further caused to:
cause, at least in part, a generation of at least one report of the redemption, the validation, the confirmation, or a combination thereof.

18. An apparatus of claim 11, wherein the radio frequency memory tag is unique to the merchant, one or more point-of-sales systems associated with the merchant, one or more clerks associated with the merchant, or a combination thereof.

19. An apparatus of claim 11, wherein the apparatus is further caused to:
cause, at least in part, a capture of promotional information, a point of sales identifier, product information, or a combination thereof related to a product available for purchase from the merchant; and
determine an input for selecting to purchase the product based, at least in part, on the promotional information, the one or more offers, the point of sales identifier, the product information, or a combination thereof.

20. A method of claim 19, wherein the apparatus is further caused to:
cause, at least in part, a generation of a payment for purchasing the product based, at least in part, on the selection to purchase, the merchant information, user information, or a combination thereof.
